(19) United States
(12) Patent Application Publication
(10) Pub. No.: US 2025/0048358 A1
(43) Pub. Date: Feb. 6, 2025

(54) METHOD FOR WIRELESS COMMUNICATION, TERMINAL DEVICE AND NETWORK DEVICE

(71) Applicant: GUANGDONG OPPO MOBILE TELECOMMUNICATIONS CORP., LTD., Dongguan (CN)

(72) Inventors: Zhe LIU, Dongguan (CN); Zhihua SHI, Dongguan (CN); Wenhong CHEN, Dongguan (CN)

(21) Appl. No.: 18/919,684

(22) Filed: Oct. 18, 2024

Related U.S. Application Data
(63) Continuation of application No. PCT/CN2022/088262, filed on Apr. 21, 2022.

(51) Int. Cl. H04W 72/1268; H04L 5/00; H04W 72/231

(52) U.S. Cl. CPC H04W 72/1268; H04L 5/0051; H04W 72/231

(57) ABSTRACT

A method for wireless communication includes: determining, by a terminal device, a transmission mode for at least two phase-tracking reference signals (PT-RSs), where the at least two PT-RSs correspond to at least two physical uplink shared channels (PUSCHs); and transmitting the at least two PUSCHs according to the transmission mode for the at least two PT-RSs, where the at least two PUSCHs are associated with different spatial parameters; where the transmission mode for the at least two PT-RSs includes at least one of the following: a portion of PT-RSs of the at least two PT-RSs being not transmitted; or that at least portion of resource locations of the at least two PT-RSs being not overlapped.

### CROSS-REFERENCE TO RELATED APPLICATION

This application is a Continuation Application of International Application No. PCT/CN2022/088262 filed Apr. 21, 2022, which is incorporated herein by reference in its entirety.

### TECHNICAL FIELD

Embodiments of the present application relate to the field of communications, and in particular, to a method for wireless communication, a terminal device, and a network device.

### BACKGROUND

A phase-tracking reference signal (PT-RS) is used to track phase noise caused by local oscillators in a base station and a terminal device. The phase noise corrupts sub-carriers' orthogonality in an orthogonal frequency-division multiplexing (OFDM) system, which causes a common phase error (CPE). The CPE has a great impact on system performance, and CPE compensation may eliminate the CPE to a certain extent.

In some scenarios, it is considered to support simultaneous transmission of physical uplink shared channels (PUSCHs) by a terminal device to two transmission reception points (TRPs), which may cause a resource location conflict between PT-RSs corresponding to the two PUSCHs in a case where resource locations of two PUSCHs overlap, thereby reducing the performance of the common phase error compensation. In addition, the resource location conflict between PT-RSs may result in a power boost of PT-RSs, which may lead to an increased interference level. Consequently, how to avoid or reduce a PT-RS conflict in case of simultaneous transmission of multi-PUSCHs is an urgent issue to be solved.

### SUMMARY

In a first aspect, a method for wireless communication is provided, which includes: determining, by a terminal device, a transmission mode for at least two phase-tracking reference signals (PT-RSs), where the at least two PT-RSs correspond to at least two physical uplink shared channels (PUSCHs); and transmitting the at least two PUSCHs according to the transmission mode for the at least two PT-RSs, where the at least two PUSCHs are associated with different spatial parameters;
where the transmission mode for the at least two PT-RSs includes at least one of the following:
a portion of PT-RSs of the at least two PT-RSs being not transmitted; or
at least portion of resource locations of the at least two PT-RSs being not overlapped.

In a second aspect, a method for wireless communication is provided, which includes:
determining, by a network device, a transmission mode for at least two phase-tracking reference signals (PT-RSs), where the at least two PT-RSs correspond to at least two physical uplink shared channels (PUSCHs); and
receiving the at least two PUSCHs according to the transmission mode for the at least two PT-RSs, where the at least two PUSCHs are associated with different spatial parameters;
where the transmission mode for the at least two PT-RSs includes at least one of:
a portion of PT-RSs of the at least two PT-RSs being not transmitted; or
at least portion of resource locations of the at least two PT-RSs being not overlapped.

In a third aspect, a terminal device is provided, which is configured to perform the method according to the above first aspect or its various implementations.

Specifically, the terminal device includes a functional module configured to perform the method according to the above first aspect or its various implementations.

In a fourth aspect, a network device is provided, which is configured to perform the method according to the above second aspect or its various implementations.

Specifically, the network device includes a functional module configured to perform the method according to the above second aspect or its various implementations.

In a fifth aspect, a terminal device is provided, which includes a processor and a memory. The memory is configured to store a computer program, and the processor is configured to invoke and execute the computer program stored in the memory to perform the method according to the above first aspect or its various implementations.

In a sixth aspect, a network device is provided, which includes a processor and a memory. The memory is configured to store a computer program, and the processor is configured to invoke and execute the computer program stored in the memory to perform the method according to the above second aspect or its various implementations.

In a seventh aspect, a chip is provided, which is configured to implement the method according to any one of the above first and second aspects or their various implementations.

Specifically, the chip includes a processor, which is configured to invoke and execute a computer program from a memory to cause a device equipped with the apparatus to perform the method according to any one of the above first and second aspects or their various implementations.

In an eighth aspect, a non-transitory computer-readable storage medium is provided, which is configured to store a computer program, where the computer program causes a computer to perform the method according to any one of the above first and second aspects or their various implementations.

In a ninth aspect, a computer program product is provided, which includes a computer program instruction. The computer program instruction causes a computer to perform the method according to any one of the above first and second aspects or their various implementations.

In a tenth aspect, a computer program is provided. When executed on a computer, the computer program causes the computer to perform the method according to any one of the above first and second aspects or their various implementations.

### BRIEF DESCRIPTION OF THE DRAWINGS

FIG. 1 is a schematic diagram showing an architecture of a communication system provided in an embodiment of the present application.

FIG. 2 is a schematic flowchart of a method for wireless communication provided according to an embodiment of the present application.

FIG. 3 is a schematic diagram showing scheduling of multiple PUSCHs through multiple DCIs.

FIG. 4 is a schematic diagram showing scheduling of multiple PUSCHs through one DCI.

FIG. 5 is a schematic flowchart of another method for wireless communication provided according to an embodiment of the present application.

FIG. 6 is a schematic block diagram of a terminal device provided according to an embodiment of the present application.

FIG. 7 is a schematic block diagram of a network device provided according to an embodiment of the present application.

FIG. 8 is a schematic block diagram of a communication device provided according to an embodiment of the present application.

FIG. 9 is a schematic block diagram of a chip provided according to an embodiment of the present application.

FIG. 10 is a schematic block diagram of a communication system provided according to an embodiment of the present application.

### DETAILED DESCRIPTION

Technical solutions in the embodiments of the present application will be described below with reference to the accompanying drawings in the embodiments of the present application. It is apparent that the embodiments described are some rather than all of the embodiments of the present application. Based on the embodiments of the present application, all other embodiments obtained by a person of ordinary skill in the art fall within the protection scope of the present application.

Technical solutions according to embodiments of the present application may be applied to various communication systems, such as a global system of mobile communication (GSM) system, a code division multiple access (CDMA) system, a wideband code division multiple access (WCDMA) system, a general packet radio service (GPRS), a long term evolution (LTE) system, an advanced long term evolution (LTE-A) system, a new radio (NR) system, an evolution system of the NR system, an LTE-based access to unlicensed spectrum (LTE-U) system, an NR-based access to unlicensed spectrum (NR-U) system, a non-terrestrial networks (NTN) system, a universal mobile telecommunications system (UMTS), a wireless local area network (WLAN), wireless fidelity (Wi-Fi), a 5th-Generation (5G) communication system, and other communication systems.

Generally, traditional communication systems support a limited number of connections, and are easy to implement. However, with the development of communication technology, mobile communication systems will not only support traditional communication, but also support, for example, device to device (D2D) communication, machine to machine (M2M) communication, machine type communication (MTC), vehicle to vehicle (V2V) communication, and vehicle to everything (V2X) communication, and the embodiments of the present application may be applied to these communication systems as well.

Optionally, the communication systems in the embodiments of the present application may be applied to a carrier aggregation (CA) scenario, a dual connectivity (DC) scenario, or a standalone (SA) networking scenario.

Optionally, the communication systems in the embodiments of the present application may be applied to an unlicensed spectrum, which may also be considered as a shared spectrum. The communication systems in the embodiments of the present application may also be applied to a licensed spectrum, which may also be considered as an unshared spectrum.

Various embodiments of the present application are described in combination with a network device and a terminal device. The terminal device may also be referred to as a user equipment (UE), an access terminal, a subscriber unit, a subscriber station, a mobile station, a mobile console, a remote station, a remote terminal, a mobile device, a user terminal, a terminal, a wireless communication device, a user agent or a user apparatus.

The terminal device may be a station (ST) in the WLAN, or may be a cellular phone, a wireless phone, a session initiation protocol (SIP) phone, a wireless local loop (WLL) station, a personal digital assistant (PDA) device, a handheld device with a wireless communication function, a computing device or another processing device connected to a wireless modem, a vehicle-mounted device, a wearable device, a terminal device in a next-generation communication system (e.g., an NR network), or a terminal device in a future evolved public land mobile network (PLMN).

In an embodiment of the present application, the terminal device may be deployed on land including indoor or outdoor, handheld, wearable or vehicle-mounted; alternatively, the terminal device may be deployed on water (such as on ships); alternatively, the terminal device may be deployed aerially (such as in airplanes, balloons and satellites).

In the embodiments of the present application, the terminal device may be a mobile phone, a pad, a computer with wireless transceiving function, a virtual reality (VR) terminal device, an augmented reality (AR) terminal device, a wireless terminal device in industrial control, a wireless terminal device in self driving, a wireless terminal device in remote medical, a wireless terminal device in smart grid, a wireless terminal device in transportation safety, a wireless terminal device in smart city, a wireless terminal device in smart home, or the like.

As an example and not by way of limitation, the terminal device in embodiments of the present application may also be a wearable device. The wearable device may also be referred to as a wearable smart device, which is a general term of wearable devices developed by intelligent design and development on daily wear by applying wearable technology, such as glasses, gloves, watches, clothing and shoes. The wearable device is a portable device that is worn directly on a body, or integrated into clothes or accessories of users. The wearable device not only is a hardware device, but also implements powerful functions through software support as well as data interaction or cloud interaction. Generalized wearable smart devices include devices which are fully functional, have large sizes, and may implement complete or partial functions without relying on smart phones, such as a smart watch or smart glasses, and devices which focus on a certain kind of application functions only and need to be used in conjunction with other devices such as smart phones, such as various smart bracelets, and smart jewelries for monitoring physical signs.

In an embodiment of the present application, the network device may be a device configured to communicate with a mobile device, and may be an access point (AP) in the WLAN, a base transceiver station (BTS) in GSM or CDMA, a NodeB (NB) in WCDMA, an evolutional node B (eNB or eNodeB) in LTE, a relay station, an access point, a vehicle-mounted device, a wearable device, a network device or a gNB in an NR network, a network device in the future evolved PLMN network, or a network device in an NTN network.

As an example rather than a limitation, the network device in the embodiments of present application may have mobile characteristics. Optionally, the network device may be a satellite, or a balloon station. For example, the satellite may be a low earth orbit (LEO) satellite, a medium earth orbit (MEO) satellite, a geostationary earth orbit (GEO) satellite, a high elliptical orbit (HEO) satellite, or the like. Optionally, the network device may be a base station disposed in a location on land or in a water region.

In an embodiment of the present application, the network device may provide a service for a cell, and the terminal device communicates with the network device through a transmission resource (e.g., a frequency-domain resource, which is also referred to as a spectrum resource) used by the cell. The cell may be a cell corresponding to the network device (e.g., a base station), and the cell may belong to a macro base station, or may belong to a base station corresponding to a small cell.

The embodiments of the present application provide a method for wireless communication, which includes:
determining, by a terminal device, a transmission mode for at least two phase-tracking reference signals (PT-RSs), where the at least two PT-RSs correspond to at least two physical uplink shared channels (PUSCHs); and
transmitting the at least two PUSCHs according to the transmission mode for the at least two PT-RSs, where the at least two PUSCHs are associated with different spatial parameters;
where the transmission mode for the at least two PT-RSs includes at least one of:
a portion of PT-RSs of the at least two PT-RSs being not transmitted; or
at least portion of resource locations of the at least two PT-RSs being not overlapped.

In a possible implementation, the at least portion of the resource locations of the at least two PT-RSs being not overlapped includes RE offsets of the at least two PT-RSs being different.

In a possible implementation, determining, by the terminal device, the transmission mode for the at least two phase-tracking reference signals (PT-RSs) includes:
determining the transmission mode for the at least two PT-RSs according to target indication information, where the target indication information is used to indicate transmission information of the at least two PT-RSs.

In a possible implementation, the target indication information includes at least one of:
first indication information, used to indicate a time domain density of a PT-RS;
second indication information, used to indicate a frequency domain density of a PT-RS;
third indication information, used to indicate a resource element (RE) offset of a PT-RS;
fourth indication information, used to indicate an association between a PT-RS port and a demodulation reference signal (DMRS) port; or
fifth indication information, used to indicate whether a PT-RS is present.

In a possible implementation, the target indication information includes one fifth indication information, and the fifth indication information is used to indicate whether each PT-RS of the at least two PT-RSs is present; or
the target indication information includes at least two fifth indication information, and each of the at least two fifth indication information corresponds to one PT-RS of the at least two PT-RSs and is used to indicate whether the corresponding PT-RS is present.

In a possible implementation, the fifth indication information is carried in at least one of following signalings:
downlink control information (DCI), radio resource control (RRC), or a media access control control element (MAC CE).

In a possible implementation, the fifth indication information is carried in a first information field of DCI, and the first information field is dedicated to indicating whether a PT-RS is present.

In a possible implementation, different state values of the fifth indication information are used to indicate that the PT-RS is present and that the PT-RS is not present.

In a possible implementation, determining the transmission mode for the at least two PT-RSs according to the target indication information includes:
determining an absent PT-RS and/or a present PT-RS of the at least two PT-RSs according to the fifth indication information.

In a possible implementation, determining the absent PT-RS and/or the present PT-RS of the at least two PT-RSs according to the fifth indication information includes:
determining, according to the fifth indication information in combination with a first correspondence, the absent PT-RS and/or the present PT-RS of the at least two PT-RSs, where the first correspondence is used to indicate a correspondence between a state value of the fifth indication information and a situation about whether a PT-RS is present.

In a possible implementation, determining the transmission mode for the at least two PT-RSs according to the target indication information includes:
determining the absent PT-RS and/or the present PT-RS of the at least two PT-RSs according to the fourth indication information in combination with the fifth indication information.

In a possible implementation, determining the absent PT-RS and/or the present PT-RS of the at least two PT-RSs according to the fourth indication information in combination with the fifth indication information includes:
determining, according to the fourth indication information and the fifth indication information, in combination with a second correspondence, the absent PT-RS and/or the present PT-RS of the at least two PT-RSs, where the second correspondence is used to indicate a correspondence between a state value of the fourth indication information and a DMRS port and a correspondence between a state value of the fifth indication information under the DMRS port and a situation about whether a PT-RS is present.

In a possible implementation, determining, by the terminal device, the transmission mode for the at least two phase-tracking reference signals (PT-RSs) includes:
determining an absent PT-RS and/or a present PT-RS of the at least two PT-RSs according to a first rule, where the first rule is pre-defined, or the first rule is configured by a network device.

In a possible implementation, determining the absent PT-RS and/or the present PT-RS of the at least two PT-RSs according to the first rule includes:
in a case where fifth indication information is not received, determining the absent PT-RS and/or the present PT-RS of the at least two PT-RSs according to the first rule, where the fifth indication information is used to indicate whether a PT-RS is present.

In a possible implementation, the first fule includes:
a PT-RS on a PUSCH associated with a first spatial parameter being not present.

In a possible implementation, the first spatial parameter is a spatial parameter with a smallest index among spatial parameters associated with the at least two PUSCHs.

In a possible implementation, the at least two PUSCHs are scheduled via at least two physical downlink control channels (PDCCHs).

In a possible implementation, the target indication information includes at least one of:
first indication information, used to indicate a time domain density of a PT-RS;
second indication information, used to indicate a frequency domain density of a PT-RS;
third indication information, used to indicate an RE offset of a PT-RS;
fourth indication information, used to indicate an association between a PT-RS port and a DMRS port; or
sixth indication information, used to determine resource locations of the at least two PT-RSs.

In a possible implementation, the sixth indication information is used to indicate an additional RE offset of a PT-RS, and the additional RE offset is an additional offset relative to a reference RE offset; where the reference RE offset is indicated by the third indication information.

In a possible implementation, the additional RE offset of the PT-RS indicated by the sixth indication information is w, the reference RE offset of the PT-RS indicated by the third indication information is t, and a target RE offset of the PT-RS is (t+w) mod (12), where mod denotes a modulo operation.

In a possible implementation, the sixth indication information is used to indicate an additional RE offset associated with a spatial parameter.

In a possible implementation, an additional RE offset associated with a first spatial parameter is a first additional RE offset, and an additional RE offset associated with a second spatial parameter is a second additional RE offset; where the first spatial parameter and the second spatial parameter are different, the first additional RE offset and the second additional RE offset are non-negative integers, and the first additional RE offset and the second additional RE offset are different.

In a possible implementation, an index of the first spatial parameter is less than an index of the second spatial parameter.

In a possible implementation, different state values of the sixth indication information are used to indicate different additional RE offsets.

In a possible implementation, the sixth indication information is used to indicate an additional RE offset corresponding to each PT-RS of the at least two PT-RSs; or the sixth indication information is used to indicate additional RE offsets corresponding to a portion of PT-RSs of the at least two PT-RSs.

In a possible implementation, the sixth indication information is carried in at least one of following signalings: DCI, RRC, a MAC CE.

In a possible implementation, determining the transmission mode for the at least two PT-RSs according to the target indication information includes:
determining, according to the third indication information and the fourth indication information in combination with at least two correspondences, DMRS ports respectively associated with ports of the at least two PT-RSs and RE offsets of the at least two PT-RSs, where each of the at least two correspondences corresponds to a PT-RS, and the each of the at least two correspondences is used to determine an RE offset mapped by a port of the PT-RS on an associated DMRS port;
where in the at least two correspondences, for third indication information and fourth indication information with a same state value, the at least two PT-RSs are associated with different DMRS ports, and/or RE offsets mapped by the at least two PT-RSs are different.

In a possible implementation, the at least two correspondences comprise a third correspondence and a fourth correspondence, where an RE offset corresponding to a DMRS port j in the third correspondence is same as an RE offset corresponding to a DMRS port i in the fourth correspondence, and i and j are integers and different.

In a possible implementation, the at least two correspondences comprise a fifth correspondence and a sixth correspondence, where in the fifth correspondence and the sixth correspondence, a same DMRS port and a same state value of the third indication information correspond to different RE offsets.

In a possible implementation, determining, by the terminal device, the transmission mode for the at least two phase-tracking reference signals (PT-RSs) includes:
determining at least portion of the resource locations of the at least two PT-RSs being not overlapped according to a second rule, where the second rule is pre-defined, or the second rule is configured by a network device.

In a possible implementation, determining the at least portion of the resource locations of the at least two PT-RSs being not overlapped according to the second rule includes:
determining that the at least two PT-RSs correspond to different RE offsets according to the second rule.

In a possible implementation, the second rule includes:
an RE offset of a PT-RS corresponding to a PUSCH associated with a third spatial parameter being a third additional RE offset; and/or
an RE offset of a PT-RS corresponding to a PUSCH associated with a fourth spatial parameter being a fourth additional RE offset;
where the third spatial parameter and the fourth spatial parameter are different, the third additional RE offset and the fourth additional RE offset are different, and the third additional RE offset and the fourth additional RE offset are non-negative integers.

In a possible implementation, the third additional RE offset is x, and the fourth additional RE offset is y, y=(x+R) mod (12); where R is any positive integer, and mod denotes a modulo operation.

In a possible implementation, x is 0.

In a possible implementation, an index of the third spatial parameter is less than an index of the fourth spatial parameter.

In a possible implementation, the at least two PUSCHs are scheduled via a same PDCCH.

In a possible implementation, the first indication information is indicated per PT-RS; and/or the second indication information is indicated per PT-RS; and/or the third indication information is indicated per PT-RS.

In a possible implementation, the spatial parameters includes at least one of: transmission configuration indicator (TCI) state information, antenna panel information, transmission reception point (TRP) information, control resource set (CORESET) group information, reference signal set information, reference signal information, beam information, or capability set information.

In a possible implementation, the capability set information includes at least one of: a maximum number of sounding reference signal (SRS) ports, a maximum number of uplink transmission layers, a codebook subset type, an uplink full-power transmission mode, an SRS antenna switching capability, an SRS carrier switching capability, a number of SRS resources transmitted simultaneously, a maximum modulation mode for uplink data transmission, and a maximum modulation mode for downlink data transmission.

The embodiments of the present application further provide another method for wireless communication, which includes:
determining, by a network device, a transmission mode for at least two phase-tracking reference signals (PT-RSs), where the at least two PT-RSs correspond to at least two physical uplink shared channels (PUSCHs); and
receiving the at least two PUSCHs according to the transmission mode for the at least two PT-RSs, where the at least two PUSCHs are associated with different spatial parameters;
where the transmission mode for the at least two PT-RSs includes at least one of:
a portion of PT-RSs of the at least two PT-RSs being not transmitted; or
at least portion of resource locations of the at least two PT-RSs being not overlapped.

In a possible implementation, the at least portion of the resource locations of the at least two PT-RSs being not overlapped includes RE offsets of the at least two PT-RSs being different.

In a possible implementation, determining, by the network device, the transmission mode for the at least two phase-tracking reference signals (PT-RSs) includes:
determining the transmission mode for the at least two PT-RSs according to target indication information, where the target indication information is used to indicate transmission information of the at least two PT-RSs.

In a possible implementation, the target indication information includes at least one of:
first indication information, used to indicate a time domain density of a PT-RS;
second indication information, used to indicate a frequency domain density of a PT-RS;
third indication information, used to indicate a resource element (RE) offset of a PT-RS;
fourth indication information, used to indicate an association between a PT-RS port and a demodulation reference signal (DMRS) port; or fifth indication information, used to indicate whether a PT-RS is present.

In a possible implementation, the target indication information includes one fifth indication information, and the fifth indication information is used to indicate whether each PT-RS of the at least two PT-RSs is present; or the target indication information includes at least two fifth indication information, and each of the at least two fifth indication information corresponds to one PT-RS of the at least two PT-RSs and is used to indicate whether the corresponding PT-RS is present.

In a possible implementation, the fifth indication information is carried in at least one of following signalings:
downlink control information (DCI), radio resource control (RRC), or a media access control control element (MAC CE).

In a possible implementation, the fifth indication information is carried in a first information field of DCI, and the first information field is dedicated to indicating whether a PT-RS is present.

In a possible implementation, different state values of the fifth indication information are used to indicate that the PT-RS is present and that the PT-RS is not present.

In a possible implementation, determining the transmission mode for the at least two PT-RSs according to the target indication information includes:
determining an absent PT-RS and/or a present PT-RS of the at least two PT-RSs according to the fifth indication information.

In a possible implementation, determining the absent PT-RS and/or the present PT-RS of the at least two PT-RSs according to the fifth indication information includes:
determining, according to the fifth indication information in combination with a first correspondence, the absent PT-RS and/or the present PT-RS of the at least two PT-RSs, where the first correspondence is used to indicate a correspondence between a state value of the fifth indication information and a situation about whether a PT-RS is present.

In a possible implementation, determining the transmission mode for the at least two PT-RSs according to the target indication information includes:
determining the absent PT-RS and/or the present PT-RS of the at least two PT-RSs according to the fourth indication information in combination with the fifth indication information.

In a possible implementation, determining the absent PT-RS and/or the present PT-RS of the at least two PT-RSs according to the fourth indication information in combination with the fifth indication information includes:
determining, according to the fourth indication information and the fifth indication information, in combination with a second correspondence, the absent PT-RS and/or the present PT-RS of the at least two PT-RSs, where the second correspondence is used to indicate a correspondence between a state value of the fourth indication information and a DMRS port and a correspondence between a state value of the fifth indication information under the DMRS port and a situation about whether a PT-RS is present.

In a possible implementation, determining, by the network device, the transmission mode for the at least two phase-tracking reference signals (PT-RSs) includes:
determining an absent PT-RS and/or a present PT-RS of the at least two PT-RSs according to a first rule, where the first rule is pre-defined, or the first rule is configured by a network device.

In a possible implementation, determining the absent PT-RS and/or the present PT-RS of the at least two PT-RSs according to the first rule includes:
in a case where fifth indication information is not received, determining the absent PT-RS and/or the present PT-RS of the at least two PT-RSs according to the first rule, where the fifth indication information is used to indicate whether a PT-RS is present.

In a possible implementation, the first fule includes:
a PT-RS corresponding to a PUSCH associated with a first spatial parameter being not present.

In a possible implementation, the first spatial parameter is a spatial parameter with a smallest index among spatial parameters associated with the at least two PUSCHs.

In a possible implementation, the at least two PUSCHs are scheduled via at least two physical downlink control channels (PDCCHs).

In a possible implementation, the target indication information includes at least one of: first indication information, used to indicate a time domain density of a PT-RS; second indication information, used to indicate a frequency domain density of a PT-RS;
third indication information, used to indicate an RE offset of a PT-RS;
fourth indication information, used to indicate an association between a PT-RS port and a DMRS port; or
sixth indication information, used to determine resource locations of the at least two PT-RSs.

In a possible implementation, the sixth indication information is used to indicate an additional RE offset of a PT-RS, and the additional RE offset is an additional offset relative to a reference RE offset; where the reference RE offset is indicated by the third indication information.

In a possible implementation, the additional RE offset of the PT-RS indicated by the sixth indication information is w, the reference RE offset of the PT-RS indicated by the third indication information is t, and a target RE offset of the PT-RS is (t+w) mod (12), where mod denotes a modulo operation.

In a possible implementation, the sixth indication information is used to indicate an additional RE offset associated with a spatial parameter.

In a possible implementation, an additional RE offset associated with a first spatial parameter is a first additional RE offset, and an additional RE offset associated with a second spatial parameter is a second additional RE offset; where the first spatial parameter and the second spatial parameter are different, the first additional RE offset and the second additional RE offset are non-negative integers, and the first additional RE offset and the second additional RE offset are different.

In a possible implementation, an index of the first spatial parameter is less than an index of the second spatial parameter.

In a possible implementation, the sixth indication information is used to indicate an additional RE offset corresponding to each PT-RS of the at least two PT-RSs; or the sixth indication information is used to indicate additional RE offsets corresponding to a portion of PT-RSs of the at least two PT-RSs.

In a possible implementation, different state values of the sixth indication information are used to indicate different additional RE offsets.

In a possible implementation, the sixth indication information is carried in at least one of following signalings: DCI, RRC, a MAC CE.

In a possible implementation, determining the transmission mode for the at least two PT-RSs according to the target indication information includes:
determining, according to the third indication information and the fourth indication information in combination with at least two correspondences, DMRS ports respectively associated with ports of the at least two PT-RSs and RE offsets of the at least two PT-RSs, where each of the at least two correspondences corresponds to a PT-RS, and the each of the at least two correspondences is used to determine an RE offset mapped by a port of the PT-RS on an associated DMRS port;
where in the at least two correspondences, for third indication information and fourth indication information with a same state value, the at least two PT-RSs are associated with different DMRS ports, and/or RE offsets mapped by the at least two PT-RSs are different.

In a possible implementation, the at least two correspondences comprise a third correspondence and a fourth correspondence, where an RE offset corresponding to a DMRS port j in the third correspondence is same as an RE offset corresponding to a DMRS port i in the fourth correspondence, and i and j are integers and different.

In a possible implementation, the at least two correspondences comprise a fifth correspondence and a sixth correspondence, where in the fifth correspondence and the sixth correspondence, a same DMRS port and a same state value of the third indication information correspond to different RE offsets.

In a possible implementation, determining, by the network device, the transmission mode for the at least two phase-tracking reference signals (PT-RSs) includes:
determining at least portion of the resource locations of the at least two PT-RSs being not overlapped according to a second rule, where the second rule is pre-defined, or the second rule is configured by a network device.

In a possible implementation, determining the at least portion of the resource locations of the at least two PT-RSs being not overlapped according to the second rule includes:
determining that the at least two PT-RSs correspond to different RE offsets according to the second rule.

In a possible implementation, the second rule includes:
an RE offset of a PT-RS corresponding to a PUSCH associated with a third spatial parameter being a third additional RE offset; and/or
an RE offset of a PT-RS corresponding to a PUSCH associated with a fourth spatial parameter being a fourth additional RE offset;
where the third spatial parameter and the fourth spatial parameter are different, the third additional RE offset and the fourth additional RE offset are different, and the third additional RE offset and the fourth additional RE offset are non-negative integers.

In a possible implementation, the third additional RE offset is x, and the fourth additional RE offset is y, y=(x+R) mod (12); where R is any positive integer, and mod denotes a modulo operation.

In a possible implementation, x is 0.

In a possible implementation, an index of the third spatial parameter is less than an index of the fourth spatial parameter.

In a possible implementation, the at least two PUSCHs are scheduled via a same PDCCH.

In a possible implementation, the first indication information is indicated per PT-RS; and/or the second indication information is indicated per PT-RS; and/or the third indication information is indicated per PT-RS.

In a possible implementation, the spatial parameters includes at least one of: transmission configuration indicator (TCI) state information, antenna panel information, transmission reception point (TRP) information, control resource set (CORESET) group information, reference signal set information, reference signal information, beam information, or capability set information.

In a possible implementation, the capability set information includes at least one of: a maximum number of sounding reference signal (SRS) ports, a maximum number of uplink transmission layers, a codebook subset type, an uplink full-power transmission mode, an SRS antenna switching capability, an SRS carrier switching capability, a number of SRS resources transmitted simultaneously, a maximum modulation mode for uplink data transmission, and a maximum modulation mode for downlink data transmission.

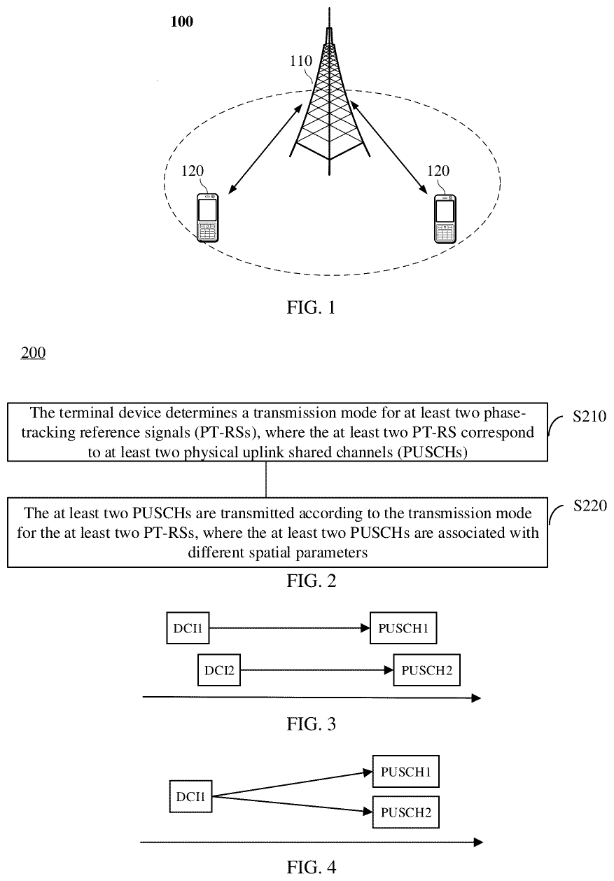

Exemplary, a communication system 100 to which the embodiments of the present application are applicable is shown in FIG. 1. The communication system 100 may include a network device 110, and the network device 110 may be a device that communicates with a terminal device 120 (or referred to as a communication terminal or a terminal). The network device 110 may provide communication coverage for a specific geographical area, and may communicate with the terminal device(s) located in the coverage area.

FIG. 1 exemplarily illustrates one network device and two terminal devices. Optionally, the communication system 100 may include a plurality of network devices, each of which may have a coverage area in which other number of terminal devices are included, which is not limited in the embodiments of the present application.

Optionally, the communication system 100 may further include a network controller, a mobile management entity or other network entities, which are not limited in the embodiments of the present application.

It should be understood that devices with communication functions in the network/system in the embodiments of the present application can be called communication devices. Taking the communication system 100 shown in FIG. 1 as an example, communication devices may include the network device 110 and the terminal device 120 that have a communication function. The network device 110 and the terminal device 120 may be the devices described above, which is not limited in the embodiments of the present application.

It should be understood that the terms “system” and “network” are often used interchangeably herein. The term “and/or” herein is only an association relationship to describe associated objects, which indicates that there may be three kinds of relationships, for example, A and/or B may indicate three cases where: A exists alone, both A and B exist, and B exists alone. In addition, the symbol “/” herein generally indicates that associated objects before and after the symbol “/” have an “or” relationship.

It should be understood that “indication” involved in embodiments of the present application may be a direct indication, may be an indirect indication, or may represent an association relationship. For example, A indicating B may mean that A indicates B directly, for example, B can be acquired through A; or A indicating B may mean that A indicates B indirectly, for example, A indicates C, and B can be acquired through C; or A indicating B may mean that there is an association between A and B.

In the description of the embodiments of the present application, the term “correspond” may mean that there is a directly corresponding or an indirectly correspondence between two parties, or mean that there is an association between two parties, or mean a relationship such as indicating and being indicated, or configuring and being configured.

In the embodiments of the present application, “predefined” may be achieved by pre-storing corresponding codes, tables or other manners that may be used to indicate relevant information in devices (e.g., including a terminal device and a network device). The specific implementation is not limited in the present application. For example, “predefined” may refer to those defined in a protocol.

In the embodiments of the present application, “protocols” may refer to standard protocols in the field of communication, which may include, for example, a LTE protocol, an NR protocol and the relevant protocol applied in the future communication system, which is not limited in the present application.

In order to facilitate a better understanding of the embodiments of the present application, the transmission configuration indicator (TCI) state of the downlink signal transmission related to the present application will be described.

In the NR system, the network device may configure a corresponding TCI state for each downlink signal or downlink channel to indicate a quasi-co-located (QCL) reference signal corresponding to the target downlink signal or target downlink channel, so that the terminal device receives the target downlink signal or target downlink channel based on the reference signal.

A TCI state may include the following configurations:
TCI state ID used to identify a TCI state;
QCL information 1; or
QCL Information 2.

One QCL information contains the following information:
QCL type configuration, which may be one of QCL type A, QCL type B, QCL type C, and QCL type D; and
QCL reference signal configuration including a cell ID where the reference signal is located, a bandwidth part (BWP) ID, and a reference signal identifier (which may be a channel state information reference signal (CSI-RS) resource ID or a synchronization signal block (SSB) index).

A QCL type of at least one of QCL information 1 and QCL information 2 must be one of type A, type B, and type C, and the QCL type of the other QCL information (if configured) must be the QCL type D.

The definitions of different QCL type configurations are as follows:
‘QCL-TypeA’: {Doppler shift, Doppler spread, average delay, delay spread};
‘QCL-TypeB’: {Doppler shift, Doppler spread};
‘QCL-TypeC “: {Doppler shift, average delay};
‘QCL-TypeD’: {Spatial Rx parameter}.

If the network device configures the QCL reference signal of the target downlink channel to be a reference SSB or a reference CSI-RS resource through the TCI state, and the QCL type is configured to be type A, type B or type C, the terminal device may assume that target large-scale parameters of the target downlink channel are the same as target large-scale parameters of the reference SSB or reference CSI-RS resource and thus uses the same corresponding receiving parameters for reception, and the target large-scale parameters are determined through the QCL type configuration. Similarly, if the network device configures the QCL reference signal of the target downlink channel to be a reference SSB or a reference CSI-RS resource through the TCI state, and the QCL type is configured to be type D, the terminal device may use the same receiving beam (i.e., spatial Rx parameters) as that for receiving the reference SSB or reference CSI-RS resource to receive the target downlink channel. Typically, the target downlink channel and its reference time synchronization/broadcast channel (SSB/PBCH) or reference CSI-RS resource are transmitted by the same TRP or the same antenna panel (panel) or the same beam at the network side. If the transmission TRPs or transmission panels or transmission beams for two downlink signals or channels are different, different TCI states are usually configured.

For a downlink control channel, the TCI state may be indicated by radio resource control (RRC) signaling or RRC signaling combined with media access control (MAC) signaling. For a downlink data channel, an available TCI state set is indicated by RRC signaling, some of the TCI states are activated by MAC layer signaling, and finally, one or two TCI states of the activated TCI states are indicated by a TCI state indication field of downlink control information (DCI) for a PDSCH scheduled by the DCI. For example, the network device indicates N candidate TCI states via RRC signaling, activates K TCI states via MAC signaling, and finally indicates 1 or 2 used TCI states from the activated TCI states via the TCI state indication field of the DCI.

To facilitate understanding of the technical solutions of the embodiments of the present application, the uplink beam management related to the present application will be described.

In an NR system, the terminal device may use analog beams to transmit uplink data and uplink control information. The terminal device may perform uplink beam management based on a sounding reference signal (SRS) to determine the analog beams used for uplink transmission. Specifically, the network device may configure an SRS resource set 1 for the terminal device, and the SRS resource set 1 includes N SRS resources (N>1). The terminal device may use different beams to transmit the N SRS resources. The network side measures the reception quality of the N SRS resources respectively and selects K SRS resources with the best reception quality. The network side may configure another SRS resource set 2 including K SRS resources, and enable the terminal to use analog beams used by the K SRS resources selected from the SRS resource set 1 to transmit the SRS resources in the SRS resource set 2, which may be achieved by configuring the K SRS resources selected in the SRS resource set 1 as reference SRS resources for the K SRS resources in the SRS resource set 2 respectively. In this case, based on the SRSs transmitted by the terminal device in the SRS resource set 2, the network side may select an SRS resource with the best reception quality and notify the terminal device of the corresponding SRS resource indicator (SRI). After receiving the SRI, the terminal device determines the analog beam used for the SRS resource indicated by the SRI as the analog beam used for transmitting a physical uplink shared channel (PUSCH).

In order to determine a beam used for PUCCH transmission, in an NR system, a way of radio resource control (RRC) combined with media access control (MAC) signaling is used to indicate the beam used to transmit UCI on each PUCCH resource. Specifically, N PUCCH spatial relation information (PUCCH-spatialrelationinfo) are first configured through the high-layer signaling, and then the spatial relation information corresponding to each PUCCH resource is determined from the N PUCCH-spatialrelationinfo through the MAC signaling.

To facilitate understanding of the technical solutions of the embodiments of the present application, the phase-tracking reference signal (PT-RS) will be described.

The PT-RS is used to track phase noise caused by local oscillator in a base station and a UE. The phase noise corrupts sub-carriers' orthogonality in an orthogonal frequency-division multiplexing (OFDM) system, which causes a common phase error (CPE). The CPE has a great impact on system performance. Therefore, compensation for CPE is considered in the NR system.

I. Time domain density of the PT-RS

The density of the PT-RS in the time domain depends on the quality of link transmission. When the link channel condition is good, fewer PT-RS symbols may be used to complete phase estimation. When the link channel condition is poor, more PT-RS symbols are required to complete the phase estimation. As shown in Table 1, the time domain density of the PT-RS is related to a modulation and coding scheme (MCS) level. The PT-RS may be not present, or may be transmitted in every symbol, every 2 symbols, or every 4 symbols.

TABLE 1

| | Time domain density |
|---|---|
| Scheduled MCS | (L_{PT-RS}) |
| I_{MCS} < ptrs-MCS₁ | PT-RS is not present |
| ptrs-MCS1 ≤ I_{MCS} < | 4 |
| ptrs-MCS2 | |
| ptrs-MCS2 ≤ I_{MCS} < | 2 |
| ptrs-MCS3 | |
| ptrs-MCS3 ≤ I_{MCS} < | 1 |
| ptrs-MCS4 | |

In some cases, ptrs-MCS1, ptrs-MCS2, and ptrs-MCS3 may be configured via a time density (timeDensity) of radio resource control (RRC) parameter PTRS uplink configuration (PTRS-UplinkConfig). In stead of being configured via the RRC signaling, ptrs-MCS4 may be determined according to the MCS table used. For example, the value of ptrs-MCS4 may be 29 or 28.

As shown in Table 1, when the scheduled MCS is greater than or equal to ptrs-MCS1 and less than ptrs-MCS2, the time domain density of the PT-RS is 4, that is, the PT-RS is present once every 4 OFDM symbols.

Optionally, if timeDensity is not configured, the time domain density of the PT-RS may be determined to be a default time domain density, e.g., 1, that is, the PT-RS is present once every symbol.

II. Frequency density (frequency density) of the PT-RS

In the frequency domain, the PT-RS may be transmitted in each resource block (RB), or in every 2 RBs, or in every 4 RBs. As shown in Table 2, the frequency domain density of the PT-RS is related to a scheduled bandwidth.

TABLE 2

| | Frequency domain density |
|---|---|
| Scheduled bandwidth | (K_{PT-RS}) |
| N_{RB} < N_{RB0} | PT-RS is not present |
| N_{RB0} ≤ N_{RB} < N_{RB1} | 2 |
| N_{RB1} ≤ N_{RB} | 4 |

In some cases, N_{RB0}, N_{RB1} and the scheduled bandwidth N_{RB} may be configured through frequency domain density (frequencyDensity) of RRC parameter PTRS-UplinkConfig. For example, as shown in Table 2, when the scheduled bandwidth N_{RB} is greater than or equal to N_{RB0} and less than N_{RB1}, the frequency domain density of the PT-RS is 2.

If frequencyDensity is not configured, the frequency domain density of the PT-RS is a default frequency domain density, e.g., 2, that is, the PT-RS is transmitted once every 2 RBs.

III. PT-RS port

The number of PT-RS ports is related to the number of phase noise sources. In the case that there are a plurality of independent phase noise sources, each phase noise source requires a PT-RS port for phase estimation.

For a PT-RS of a PUSCH, one or two PT-RS ports may be configured. For example, the number of PT-RS ports may be configured via RRC signaling.

The number of PT-RS ports actually used may be determined in a way as follows. For codebook-based PUSCH transmission, the number of PT-RS ports actually used for a full coherent codebook is 1; for a partial coherent codebook and a non-coherent codebook, the number of PT-RS ports actually used is determined according to a precoding matrix of uplink transmission and the number of transmission layers, for example, the number of PT-RS ports actually used may be 1 or 2. In an example, for 4 antenna ports, the number of transmission layers is 4, and when a transport precoding matrix indicator (TPMI) is equal to 1 and 2, an uplink codebook is

$$\frac{1}{2 \sqrt{2}} [ \begin{matrix}1 & 1 & 0 & 0 \\ 0 & 0 & 1 & 1 \\ 1 & - 1 & 0 & 0 \\ 0 & 0 & 1 & - 1\end{matrix} ] and \frac{1}{2 \sqrt{2}} [ \begin{matrix}1 & 1 & 0 & 0 \\ 0 & 0 & 1 & 1 \\ j & - j & 0 & 0 \\ 0 & 0 & j & - j\end{matrix} ] ,$$

respectively, which is a partial coherent codebook. Based on codebooks indicated by the TPMI, it can be seen that sounding reference signal (SRS) port 0 and SRS port 2 have the same phase noise, while SRS port 1 and SRS port 3 have the same phase noise, transmission layers 0 and 1 share the same SRS port, and transmission layers 2 and 3 share the same SRS port. Assuming that the SRS port is i (i=0, 1, 2, 3), and the port for PUSCH transmission is 1000+i, thus, PT-RS port 0 is associated with PUSCH ports 1000 and 1002, and PT-RS port 1 is associated with PUSCH ports 1001 and 1003.

For non-codebook based PUSCH transmission, according to port indexes of PT-RSs configured for n SRS resources associated with a PUSCH, the same PT-RS port index corresponds to the same PT-RS port, and there are at most 2 PT-RS ports with different port indexes.

### IV. Resource Elements (REs) Occupied by the PT-RS

Since a demodulation reference signal (DMRS) port associated with the PT-RS occupies a plurality of sub-carriers in a resource block (RB), the PT-RS occupies one of the sub-carriers, it is necessary to indicate that the PT-RS is mapped to a sub-carrier of the DMRS port. The NR system uses a combination of implicit mapping and explicit indication. Table 3 shows a mapping between different DMRS ports and corresponding PT-RS sub-carriers. When the resource element offset (resourceElementOffset) configured by the high-level RRC signaling is State 01, 10, or 11, for a certain DMRS port, the sub-carrier occupied by PT-RS transmission may be determined. When the high-level parameter resourceElementOffset is not configured, the sub-carrier corresponding to 00 state is occupied by default.

TABLE 3

| | k_{ref}^{RE} | | | | | | | |
|---|---|---|---|---|---|---|---|---|
| | DM-RS configuration type 1 | | | | | | | |
| | Resource element offset | | | | DM-RS configuration type 2 | | | |
| | (resourceElementOffset) | | | | resourceElementOffset | | | |
| DM-RS | offset | offset | offset | offset | offset | offset | offset | offset |
| Port \tilde{p} | 00 | 01 | 10 | 11 | 00 | 01 | 10 | 11 |
| 0 | 0 | 2 | 6 | 8 | 0 | 1 | 6 | 7 |
| 1 | 2 | 4 | 8 | 10 | 1 | 6 | 7 | 0 |
| 2 | 1 | 3 | 7 | 9 | 2 | 3 | 8 | 9 |
| 3 | 3 | 5 | 9 | 11 | 3 | 8 | 9 | 2 |
| 4 | — | — | — | — | 4 | 5 | 10 | 11 |
| 5 | — | — | — | — | 5 | 10 | 11 | 4 |

As shown in Table 3, for example, if the PT-RS is associated with DMRS port 1, and the high-level signaling indicates that resourceElementOffset is ‘01’, the PT-RS occupies sub-carrier 4 for transmission.

To facilitate understanding of the technical solutions of the embodiments of the present application, a codebook based PUSCH transmission solution will be described.

In Step 1, a terminal device transmits an SRS for codebook to a network device.

In Step 2, the network device performs uplink channel detection according to the SRS transmitted by the terminal device, schedules resources for the terminal device, and determines the SRS resources corresponding to PUSCH transmission, the number of PUSCH transmission layers and a precoding matrix. The network device indicates the above information to the terminal device via downlink control information (DCI);

In Step 3, the terminal device receives the DCI and transmits a PUSCH according to the indication of the DCI.

In the codebook based PUSCH transmission solution, the network device indicates the SRS resources corresponding to the PUSCH, the number of transmission layers of the PUSCH, and the precoding matrix of the PUSCH to the terminal device via the DCI. Fields in the DCI include a precoding information and number of layers field (used to indicate the precoding matrix and the number of transmission layers) and an SRS resource indicator (SRI) field that is used to indicate specific SRS resources in an SRS resource set.

In some cases, the number of transmission layers of the PUSCH and the precoding matrix of the PUSCH are indicated in a way of joint coding.

To facilitate understanding of the technical solutions of the embodiments of the present application, a non-codebook based PUSCH transmission solution will be described.

In Step 1, a UE measures a downlink reference signal, obtains a candidate precoding matrix, performs precoding on an SRS by using the candidate precoding matrix, and then transmits the SRS for non-codebook to a network device.

In Step 2, the network device performs uplink channel detection according to the SRS transmitted by the terminal device, schedules resources for the UE, and determines SRS resources corresponding to a beam used for PUSCH transmission. The network device indicates the above information to the terminal device via the DCI;

In Step 3, the terminal device receives the DCI and transmits the PUSCH according to the indication of the DCI.

In the non-codebook based PUSCH transmission solution, the network device indicates the number of PUSCH transmission layers and the specific SRS resources in the SRS resource set to the terminal device via the SRI field of the DCI.

To facilitate understanding of the embodiments of the present application, a PUSCH transmission solution for multiple transmission reception points (TRPs) or multiple antenna panels will be described.

In the NR system, non-coherent transmission for downlink and uplink based on multiple TRPs is introduced. The backhaul connection between TRPs may be ideal or non-ideal. In an ideal backhaul, TRPs may exchange information quickly and dynamically. In a non-ideal backhaul, TRPs may only exchange information quasi-statically due to a large delay. In downlink non-coherent transmission, multiple TRPs may independently schedule multiple PUSCH transmissions of one terminal device by using different control channels, or schedule transmissions of different TRPs by using the same control channel, and data of different TRPs use different transmission layers. The latter can only be used in the ideal backhaul case.

In some cases, a UE may transmit PUSCHs to two TRPs in a time-division multiplexing (TDM) manner.

In some cases, a network device may schedule a terminal device to transmit PUSCHs to two TRPs via a single DCI. The PUSCHs transmitted to the two TRPs may be configured with independent transmission parameters, e.g., beams and precoding matrices, and the number of transmission layers of the PUSCHs transmitted to the two TRPs is constrained to be the same. The PUSCHs transmitted by the terminal device to different TRPs are aligned with the corresponding TRPs for analog beamforming, thereby distinguishing different PUSCHs according to the spatial domain and improving uplink spectrum efficiency.

For the codebook based PUSCH transmission, the single DCI needs to include two SRI fields and two precoding information and transmission layer number fields. The first precoding information and transmission layer number field is used to indicate precoding information and a transmission layer number of a PUSCH transmitted to TRP1, and a transmission layer number of a PUSCH transmitted to TRP2 is the same as the transmission layer number indicated by the first precoding information and transmission layer number field. The first SRI field is used to indicate a beam direction of the PUSCH transmitted to TRP1, and the second SRI field is used to indicate a beam direction of the PUSCH transmitted to TRP2. The network device configures 2 SRS resource sets, and the first SRI field and the second SRI field correspond to the 2 SRS resource sets, respectively, which are used to indicate beam directions of the PUSCHs transmitted to the two TRPs. The second precoding information and layer number field only needs to indicate the precoding information, and the number of transmission layers is the same as the number of transmission layers indicated by the first precoding information and layer number field by default.

For the non-codebook based PUSCH transmission, the single DCI needs to include two SRI fields, in which the first SRI field is used to indicate the beam direction and number of transmission layers of the PUSCH transmitted to TRP1, and the second SRI field is used to indicate the beam direction of the PUSCH transmitted to TRP2. The number of transmission layers of the PUSCH transmitted to TRP2 is the same as the number of transmission layers indicated by the first SRI.

In other cases, the network device may also schedule the terminal device to transmit PUSCHs to two TRPs via multiple DCIs, and the multiple DCIs may be carried by different control resource sets (CORESETs). The network device is configured with multiple CORESET groups, and each TRP performs scheduling by using CORESETs in its own CORESET group, that is, different TRPs may be distinguished by the CORESET group. For example, the network device may configure a CORESET group index for each CORESET, and different indexes correspond to different TRPs.

To facilitate understanding of the embodiments of the present application, PUSCH TDM repetition transmission of multiple TRPs and the mapping between PT-RSs and DMRSs will be described.

In some scenarios, the PUSCH TDM repetition transmission of multiple TRPs is enhanced. The types of PUSCH repetition transmission include PUSCH repetition type A (PUSCH repetition type A) and PUSCH repetition type B (PUSCH repetition type B). Since the number of transmission layers of PUSCH repetition type A is limited to 1, it is unnecessary to additionally indicate the mapping between PT-RS ports and DMRS ports. For PUSCH repetition type B, the number of transmission layers may be greater than 1.

When the maximum rank number (maxrank) is equal to 2 (that is, the maximum number of transmission layers is 2), only one PT-RS port is required, and 2 bits in DCI 0-1 or DCI 0-2 are used to indicate the association between PT-RS ports and DMRS ports. As shown in Table 4, the most significant bit (MSB) and the least significant bit (LSB) in the 2 bits correspond to TRP1 and TRP2, respectively. MSB in State 0 indicates that a PT-RS of the PUSCH transmitted to TRP1 is associated with the first DMRS port, and MSB in State 1 indicates that the PT-RS of the PUSCH transmitted to TRP1 is associated with the second DMRS port. LSB in State 0 indicates that a PT-RS of the PUSCH transmitted to TRP2 is associated with the first DMRS port, and LSB in State 1 indicates that the PT-RS of the PUSCH transmitted to TRP2 is associated with the second DMRS port.

TABLE 4

| MSB state | | LSB state | |
|---|---|---|---|
| value | DMRS port | value | DMRS port |
| 0 | The first DMRS port associated | 0 | The first DMRS port associated |
| | with the first SRI and the first | | with the second SRI and the second |
| | precoding information and number of | | precoding information and number of |
| | layers field | | layers field |
| 1 | The second DMRS port associated | 1 | The second DMRS port associated |
| | with the first SRI and the first | | with the second SRI and the second |
| | precoding information and number of | | precoding information and number of |
| | layers field | | layers field |

When maxrank is greater than 2 (i.e., the maximum number of transmission layers is greater than 2), one or two PT-RS ports are required depending on the TPMI and the number of transmission layers. 4 bits in DCI 0-1 or DCI 0-2 are used to indicate the association between the PT-RS ports and the DMRS ports (a PTRS-DMRS association field and a second PTRS-DMRS association field occupy 2 bits, respectively). In the case that the actual number of PT-RS ports is determined to be 1 according to the TPMI and the number of transmission layers, a DMRS port associated with the PT-RS port is determined according to Table 5. In the case that the actual number of PT-RS ports is determined to be 2 according to the TPMI and the number of transmission layers, DMRS ports associated with the PT-RS ports are determined according to Table 6. The MSB and LSB in Table 6 are respectively associated with different TRPs, and the DMRS port associated with the PT-RS is determined by states of the MSB and LSB.

TABLE 5

| State value | DMRS port |
|---|---|
| 0 | The first DMRS port |
| 1 | The second DMRS port |
| 2 | The third DMRS port |
| 3 | The fourth DMRS port |

TABLE 6

| MSB | | LSB | |
|---|---|---|---|
| state | | state | |
| value | DMRS port | value | DMRS port |
| 0 | The first DMRS port | 0 | The first DMRS port |
| | sharing PT-RS port 0 | | sharing PT-RS port 1 |
| 1 | The second DMRS port | 1 | The second DMRS port |
| | sharing PT-RS port 0 | | sharing PT-RS port 1 |

In the related art, it is only supported that a terminal device transmits uplink transmissions to two TRPs in the TDM manner. In some cases, the terminal device is considered to simultaneously transmit PUSCHs to multiple panels or multiple TRPs in a frequency-division multiplexing (FDM) or spatial-division multiplexing (SDM) manner. In this case, location conflict between PT-RSs may occur, thereby reducing the performance of common phase error compensation. In addition, a power boost of PT-RSs may also lead to an increased interference level. How to avoid or reduce a PT-RS conflict in case of simultaneous transmission of multi-PUSCHs is an urgent issue to be solved.

In order to facilitate understanding of the technical solutions of the embodiments of the present application, the technical solutions of the present application will be described in detail below through specific embodiments. The following relevant technologies, as optional solutions, can be arbitrarily combined with the technical solutions of the embodiments of the present application, and these combined solutions all fall within the protection scope of the embodiments of the present application. The following relevant technologies, as optional solutions, can be arbitrarily combined with the technical solutions of the embodiments of the present application, and these combined solutions all fall within the protection scope of the embodiments of the present application.

FIG. 2 is a schematic flowchart of a method 200 for wireless communication according to an embodiment of the present application. The method 200 may be performed by a terminal device in the communication system shown in FIG. 1. As shown in FIG. 2, the method 200 includes the following contents.

In S210, the terminal device determines a transmission mode for at least two phase-tracking reference signals (PT-RSs), where the at least two PT-RS correspond to at least two physical uplink shared channels (PUSCHs).

In S220, the at least two PUSCHs are transmitted according to the transmission mode for the at least two PT-RSs, where the at least two PUSCHs are associated with different spatial parameters.

The transmission mode for the at least two PT-RSs includes at least one of the following:
a portion of PT-RSs of the at least two PT-RSs being not transmitted; or
at least portion of resource locations of the at least two PT-RSs being not overlapped.

In some embodiments of the present application, the at least two PUSCHs are transmitted simultaneously.

For example, the at least two PUSCHs are transmitted simultaneously in the FDM or SDM manner.

In some embodiments of the present application, the at least two PUSCHs being transmitted simultaneously may include:
time-frequency resources of the at least two PUSCHs being overlapped. For example, time domain resources of the at least two PUSCHs partially overlap, or the time domain resources of the at least two PUSCHs completely overlap.

In some embodiments, the time-frequency resources of the at least two PUSCHs overlap, which may include:
that the at least two PUSCHs are transmitted in the same time unit, or that the at least two PUSCHs have overlapped time domain resources in one time unit. Optionally, the time unit here may be a time slot, a sub-slot, an OFDM symbol, or the like, which is not limited in the present application.

In some embodiments of the present application, that the at least two PUSCHs are associated with different spatial parameters may refer to that the at least two PUSCHs are associated with at least two spatial parameters, where each PUSCH corresponds to a spatial parameter, and different PUSCHs correspond to different spatial parameters.

It should be understood that the spatial parameters in the embodiments of the present application may refer to a spatial setting or a spatial relation for PUSCH transmission.

In some embodiments of the present application, the spatial parameters include but are not limited to at least one of the following:
transmission configuration indicator (TCI) state information, antenna panel information, TRP information, control resource set (CORESET) group information, reference signal set information, reference signal information, beam information, or capability set information.

In some embodiments, the antenna panel information may include an antenna panel ID or index.

In some embodiments, the TRP information may include a TRP ID or index.

In some embodiments, the CORESET group information may include an ID or index of a CORESET group.

In some embodiments, the reference signal set information may be synchronization signal block (SSB) resource set information, channel state information reference signal (CSI-RS) resource set information, or SRS resource set information.

For example, the reference signal set information may include an index of a reference signal set, such as an index of an SSB set, an index of a CSI-RS resource, or an index of an SRS resource.

In some embodiments, the reference signal information may include SSB resource information, CSI-RS resource information, or SRS resource information. For example, the reference signal information may be an index of an SRS resource, an SSB resource, or a CSI-RS resource.

In some embodiments, the beam information may include a beam ID or index.

In the embodiment of the present application, the beam may also be referred to as a spatial domain transmission filter (or spatial domain filter for transmission), a spatial domain reception filter (or spatial domain filter for reception), or a spatial reception parameter (spatial Rx parameter).

In some embodiments, the capability set information may include one or more parameters. For example, the capability set information may be a capability set supported by the terminal device or reference signal information associated with a capability set supported by the terminal device.

In some embodiments, the capability set information includes but is not limited to at least one of the following:
a maximum number of SRS ports, a maximum number of uplink transmission layers, a codebook subset type, an uplink full-power transmission mode, an SRS antenna switching capability, an SRS carrier switching capability, a number of SRS resources transmitted simultaneously, a maximum modulation mode for uplink data transmission, a maximum modulation mode for downlink data transmission, a number of hybrid automatic repeat request (HARQ) processes supported by the terminal device, a channel bandwidth supported by the terminal device, a number of transmitting antennas supported by the terminal device, a PDSCH processing capability, a PUSCH processing capability, a power saving capability of the terminal device, a coverage enhancement capability of the terminal device, a data transmission rate improvement capability of the terminal device, a short delay processing capability of the terminal device, a small data transmission capability of the terminal device, an inactive data transmission capability of the terminal device, a transmission reliability capability of the terminal device, a URLLC data transmission capability of the terminal device.

In some embodiments, that a PUSCH is associated with TCI state information may include:
that a transmit beam of the PUSCH is determined based on the TCI state information.

In some embodiments, that a PUSCH is associated with antenna panel information may include:
that the PUSCH is transmitted through an antenna panel indicated by the antenna panel information.

In some embodiments, that a PUSCH is associated with TRP information may include: that the PUSCH is transmitted to a TRP indicated by the TRP information.

In some embodiments, that a PUSCH is associated with CORESET group information may include:
that a CORESET group indicated by the CORESET group information is the CORESET group to which a CORESET where a PDCCH triggering the PUSCH is located belongs, or that the CORESET group is a CORESET group configured by the higher layer signaling for resources for transmitting the PUSCH.

In some embodiments, that a PUSCH is associated with reference signal set information may include:
a reference signal set associated with an antenna panel used to transmit the PUSCH, or a reference signal set configured by the network device for the PUSCH, or a reference signal set associated with a PDCCH corresponding to the PUSCH.

In some embodiments, that a PUSCH is associated with reference signal information may include:
that a beam used to transmit the PUSCH is determined according to a transmit beam of a reference signal indicated by the reference signal information, or is determined according to a receive beam of the reference signal indicated by the reference signal information.

In some embodiments, that a PUSCH is associated with beam information may include:
the PUSCH is transmitted through a beam indicated by the beam information.

In some embodiments, that a PUSCH is associated with capability set information may include:
that transmission parameters of the PUSCH are determined according to the capability set information.

In some embodiments of the present application, the correspondence between at least two PT-RSs and at least two PUSCHs may include:
the at least two PT-RSs being used for phase tracking of the at least two PUSCHs.

In some embodiments, the at least two PT-RSs and the at least two PUSCHs may be in a one-to-one correspondence, that is, one PT-RS is used for phase tracking of one PUSCH.

In some embodiments, a PT-RS is also called a PUSCH PT-RS, or a PT-RS for PUSCH.

In some embodiments, the at least two PUSCHs are associated with at least two spatial parameters, and the at least two PT-RSs correspond to the at least two PUSCHs. It may also be considered that the at least two PT-RSs are associated with the at least two spatial parameters, that is, different PT-RSs are associated with different spatial parameters. It should be understood that, for the association between PT-RS and spatial parameter, references are made to explanations of the association between PUSCH and spatial parameter, which will not be repeated here.

In some embodiments, the at least two PUSCHs may be scheduled by the at least two PDCCHs, or in other words, the at least two PUSCHs may be scheduled by at least two DCIs. For example, each PUSCH is scheduled by one PDCCH or DCI.

As shown in FIG. 3, DCI1 schedules the transmission of PUSCH1, and DCI2 schedules the transmission of PUSCH2. PUSCH1 and PUSCH2 overlap in resources, so there is a conflict problem between the PT-RSs corresponding to PUSCH1 and PUSCH2.

In some embodiments, the at least two PUSCHs may be scheduled by one PDCCH, or in other words, the at least two PUSCHs may be scheduled by one DCI.

As shown in FIG. 4, DCI1 schedules the transmission of PUSCH1 and PUSCH2.

PUSCH1 and PUSCH2 overlap in resources, so there is a conflict problem between the PT-RSs corresponding to PUSCH1 and PUSCH2.

In some embodiments, the number of ports of a PT-RS corresponding to each PUSCH of the at least two PUSCHs is the same or different.

For example, the at least two PUSCHs include a first PUSCH and a second PUSCH, and the number of ports of the PT-RS corresponding to the first PUSCH and the number of ports of the PT-RS corresponding to the second PUSCH are both 1. As another example, the number of ports of the PT-RS corresponding to the first PUSCH is 1, and the number of ports of the PT-RS corresponding to the second PUSCH is 2.

In some embodiments of the present application, in the case that the at least two PUSCHs are scheduled for simultaneous transmission, the following transmission modes may be used to avoid or reduce the problem of conflict between PT-RSs corresponding to the at least two PUSCHs:
Mode 1: a portion of PT-RSs of the at least two PT-RSs being not transmitted;
Mode 2: at least portion of resource locations of the at least two PT-RSs being not overlapped.

In some embodiments, the portion of PT-RSs of the at least two PT-RSs being not transmitted may also be expressed as:
a portion of PT-RSs of the at least two PT-RSs being not present, or a portion of PUSCHs of the at least two PUSCHs not including PT-RSs, or a portion of PUSCHs of the at least two PUSCHs not corresponding to PT-RSs.

In some embodiments, in the case that the resource locations of the at least two PT-RSs indicated by the network device overlap, using Mode 1 to transmit the at least two PUSCHs is beneficial to avoiding the conflict problem of PT-RSs corresponding to PUSCHs transmitted simultaneously.

In some embodiments, the resource locations of a PT-RS are determined based on information such as the time domain density, frequency domain density, and an RE offset of the PT-RS.

Optionally, the time domain density of the PT-RS may be indicated by the network device, or may be a default time domain density.

Optionally, the frequency domain density of the PT-RS may be indicated by the network device, or may be a default frequency domain density.

Optionally, the RE offset of the PT-RS may be indicated by a network device.

In the following, the specific implementation of the above-mentioned Mode 1 and Mode 2 are respectively described with references to Example 1 and Example 2.

### Embodiment 1

In some embodiments of the present application, a present PT-RS and/or an absent PT-RS of the at least two PT-RSs are indicated by the network device, or determined according to a predefined rule.

For example, the network device may explicitly indicate the present PT-RS and/or absent PT-RS of the at least two PT-RSs.

As another example, PT-RSs associated with a first type of spatial parameter in the at least two PT-RSs are pre-defined to be not present, and/or PT-RSs associated with a second type of spatial parameter are pre-defined to be present.

In some embodiments, the first type of spatial parameter may be a spatial parameter with the smallest index among the spatial parameters associated with the at least two PT-RSs, and the second type of spatial parameter may be a spatial parameter with the largest index among the spatial parameters associated with the at least two PT-RSs.

In some other embodiments, the first type of spatial parameter may be the spatial parameter with the largest index among the spatial parameters associated with the at least two PT-RSs, and the second type of spatial parameter may be the spatial parameter with the smallest index among the spatial parameters associated with the at least two PT-RSs.

In some embodiments, in the case that the at least two PUSCHs are scheduled via the at least two PDCCHs, the terminal device uses Mode 1 to transmit the at least two PUSCHs.

In some embodiments of the present application, S210 may include:
determining the transmission mode for the at least two PT-RSs according to target indication information, where the target indication inforamtion is used to indicate transmission information of the at least two PT-RSs.

For example, according to the target indication information, the present PT-RS and/or
absent PT-RS of the at least two PT-RSs are determined.

In some embodiments, the target indication information is used to indicate the transmission mode for the at least two PT-RSs.

For example, the target indication information is used to indicate at least one of the following:
a time domain density of a PT-RS, a frequency domain density of a PT-RS, an RE offset of a PT-RS, an association between a PT-RS port and a DMRS port, and whether a PT-RS is present.

That is, whether the PT-RS is transmitted may be determined according to the target indication information. In the case where a PT-RS is transmitted, the resource location for transmitting the PT-RS may also be determined.

In some embodiments, the target indication information includes but is not limited to at least one of the following:
first indication information used to indicate a time domain density of a PT-RS;
second indication information used to indicate a frequency domain density of a PT-RS;
third indication information used to indicate a resource element (RE) offset of a PT-RS;
fourth indication information used to indicate an association between a PT-RS port and a DMRS port; or
fifth indication information used to indicate whether a PT-RS is present.

It should be understood that the above-mentioned indication information may be carried in the same signaling, or may also be carried in different signaling. The present application does not limit the carrying manner of the indication information.

In some embodiments, the first indication information may be transmitted via high-layer signaling. For example, the high-layer signaling may include RRC signaling.

Optionally, in the case where the terminal device does not receive the first indication information, a default time domain density may be used, e.g., being present once every OFDM symbol.

In some embodiments, the second indication information may be transmitted via high-layer signaling. For example, the high-layer signaling may include RRC signaling.

Optionally, in the case where the terminal device does not receive the second indication information, a default frequency domain density may be used, for example, being present once every two RBs.

In some embodiments, the third indication information may be transmitted via high-layer signaling. For example, the high-layer signaling may include RRC signaling.

Optionally, in the case where the terminal device does not receive the third indication information, a default RE offset may be used, such as occupying sub-carrier 0.

In some embodiments, the fourth indication information may be transmitted via dynamic signaling. For example, the dynamic signaling may include DCI signaling.

In some embodiments, the fifth indication information is transmitted via at least one of the following signalings: DCI, RRC signaling, or a MAC CE.

In some embodiments, the target indication information includes one fifth indication information, and the fifth indication information is used to indicate whether each PT-RS of the at least two PT-RSs is present.

For example, in the case where the at least two PUSCHs are scheduled by one DCI, the DCI may include a sigle fifth indication information for indicating whether each PT-RS of the at least two PT-RSs is present. Optionally, in this case, the number of bits of the fifth indication information may be determined according to the number of the at least two PT-RSs, or in other words, according to the number of spatial parameters associated with the at least two PUSCHs. For example, if the at least two PUSCHs are associated with two panels or two TRPs, the fifth indication information may include 2 bits.

In some embodiments, the target indication information includes at least two fifth indication information, each fifth indication information corresponds to one PT-RS of the at least two PT-RSs and is used to indicate whether a corresponding PT-RS is present.

For example, in the case where the at least two PUSCHs are scheduled by at least two DCIs, each DCI may include a fifth indication information for indicating whether the PT-RS corresponding to the scheduled PUSCH is present. Optionally, in this case, the fifth indication information may include 1 bit, and is used to indicate whether the corresponding PT-RS is present.

In some embodiments, in the case where the fifth indication information is transmitted via DCI, the fifth indication information may be carried in an existing information field of the DCI, such as a reserved field, or the existing information field of the DCI may be extended to add a function of indicating whether a PT-RS is present.

In other embodiments, when the fifth indication information is transmitted via DCI, a new information field may be added to the DCI to indicate whether the PT-RS is present. The present application does not limit the manner in which the fifth indication information is carried in the DCI.

In some embodiments, the fifth indication information is carried in a first information field of the DCI, and the first information field is specifically used to indicate whether a PT-RS is present. For example, the first information field may be a newly added information field or an independent information field in the DCI.

In some embodiments, different state values of the fifth indication information are used to indicate the presence of PT-RS and the absence of PT-RS.

Optionally, the fifth indication information may include 1 bit, and is used to indicate whether the PT-RS corresponding to the PUSCH scheduled by the DCI is present.

For example, when the fifth indication information is in State 0, it indicates that the PT-RS is not present, that is, the PT-RS is not transmitted.

As another example, when the fifth indication information is in state 1, it indicates that the PT-RS is present, that is, the PT-RS is transmitted.

In some other embodiments, the fifth indication information is carried in a second information field of the DCI, and the second information field is used to carry the fourth indication information, that is, used to indicate an association between a PT-RS port and a DMRS port.

For example, the second information field of the DCI may be extended to add a function of indicating whether the PT-RS is present.

It should be understood that the embodiment of the present application does not limit the position(s) of the bit(s) occupied by the fifth indication information and the fourth indication information in the second information field.

For example, the second information field includes 3 bits, the fifth indication information occupies 1 bit, and the fourth indication information occupies 2 bits, then the 1 bit of the fifth indication information may be located in the middle of the 2 bits occupied by the fourth indication information. That is, the MSB (i.e., B2) and the LSB (i.e., B0) are used to carry the fourth indication information, and the middle bit (i.e., B1) is used to carry the fifth indication information.

As another example, the second information field includes 4 bits, the fifth indication information occupies 2 bits, the fourth indication information occupies 2 bits, and the 2 bits of the fifth indication information may be inserted between the 2 bits occupied by the fourth indication information. For example, the highest 2 bits of the second information field are used to carry 1 bit of the fourth indication information and 1 bit of the fifth indication information, and the lowest 2 bits are used to carry another 1 bit of the fourth indication information and another 1 bit of the fifth indication information.

In some embodiments, if the fifth indication information indicates that the PT-RS is not present, the second information field may occupy 0 bits, that is, the second information field is not included in the DCI, that is, when PT-RS is not present, it is unnecessary to indicate the association between a PT-RS port and a DMRS port.

In some embodiments of the present application, the determining the transmission mode for the at least two PT-RSs according to the target indication information includes:
determining the absent PT-RS and/or present PT-RS of the at least two PT-RSs according to the fifth indication information.

That is, the terminal device may decode the fifth indication information separately to determine the absent PT-RS and/or present PT-RS in the at least two PT-RSs.

For example, the at least two PUSCHs are scheduled by at least two DCIs, each DCI includes a first information field, and the first information field is used to carry fifth indication information. The terminal device may decode the first information field of each DCI to determine whether the PT-RS corresponding to the PUSCH scheduled by each DCI is present.

In some embodiments, the terminal device may determine the absent PT-RS and/or the present PT-RS of the at least two PT-RSs according to the fifth indication information in combination with the first correspondence, where the first correspondence is used to indicate a correspondence between a state value of the fifth indication information and a situation about whether a PT-RS is present.

For example, the first correspondence may be described as:
the state value of the fifth indication information is 0, which is corresponding to that the PT-RS is not present; and
the state value of the fifth indication information is 1, which is corresponding to that the PT-RS is present.

It should be understood that the present application does not limit the representation of the first correspondence. For example, the first correspondence may be represented by a table, or may also be represented by a tree or code, which is not limited in the present application.

In some other embodiments of the present application, the determining the transmission mode for the at least two PT-RSs according to the target indication information includes:
determining the absent PT-RS and/or the present PT-RS of at least two PT-RSs according to the fourth indication information in combination with the fifth indication information.

That is, the terminal device may jointly decode the fourth indication information and the fifth indication information to determine the absent PT-RS and/or the present PT-RS of at least two PT-RSs.

Optionally, the fourth indication information and the fifth indication information may be carried in the same information domain, or may be carried in different information domains.

For example, the at least two PUSCHs are scheduled via at least two DCIs, each DCI includes a second information field, and the second information field is used to carry the fourth indication information and the fifth indication information. The terminal device may decode the second information field of each DCI to determine whether the PT-RS corresponding to the PUSCH scheduled by the DCI is present.

As another example, the at least two PUSCHs are scheduled via at least two DCIs, each DCI includes a first information field and a second information field, the first information field is used to carry the fifth indication information, and the second information field is used to carry the fourth indication information. The terminal device may jointly decode the first information field and the second information field of each DCI to determine whether the PT-RS corresponding to the PUSCH scheduled by the DCI is present.

As another example, the at least two PUSCHs are scheduled via a single DCI, and the single DCI includes at least two second information fields, and each second information field is used to carry fourth indication information and fifth indication information associated with a spatial parameter. The terminal device may decode the second information fields of the single DCI to determine whether the PT-RS corresponding to the PUSCH associated with each spatial parameter is present.

As another example, the at least two PUSCHs are scheduled via a single DCI, and the single DCI includes at least two first information fields and at least two second information fields. Each first information field is used to carry fifth indication information associated with a spatial parameter, and each second information field is used to carry fourth indication information associated with a spatial parameter. The terminal device may decode the first information field and the second information field associated with each spatial parameter in the single DCI to determine whether the PT-RS corresponding to the PUSCH associated with the spatial parameter is present.

In some embodiments, the terminal device may determine the absent PT-RS and/or present PT-RS of the at least two PT-RSs according to the fourth indication information and the fifth indication information in combination with a second correspondence. The second correspondence is used to indicate a correspondence between a state value of the fourth indication information and a DMRS port and a correspondence between a state value of the fifth indication information under the DMRS port and a situation about whether a PT-RS is present.

It should be understood that the present application does not limit the representation of the second correspondence. For example, the second correspondence may be represented by a table, or may also be represented by a statement, text or code, which is not limited in the present application.

Optionally, if maxrank is greater than 2, that is, the number of transmission layers is greater than 2, and the number of ports of a PT-RS is 1, the fifth indication information may include 1 bit. As an example, the second correspondence may be as shown in Table 7.

In the example of Table 7, if a PT-RS port is determined to be associated with the first DMRS port based on the state value of the fourth indication information, it may be further determined whether the PT-RS is present in combination with the state value of the fifth indication information. For example, if the state value is 0, it indicates that the PT-RS is not present; or, if the state value is 1, it indicates that the PT-RS is present.

TABLE 7

| State | | The fifth indication information |
|---|---|---|
| value | DMRS Port | includes 1 bit |
| 0 | The first DMRS port | State 0: PT-RS is not present |
| | | State 1: PT-RS is present |
| 1 | Second DMRS port | State 0: PT-RS is not present |
| | | State 1: PT-RS is present |
| 2 | The third DMRS port | State 0: PT-RS is not present |
| | | State 1: PT-RS is present |
| 3 | The fourth DMRS | State 0: PT-RS is not present |
| | port | State 1: PT-RS is present |

Optionally, if maxrank is greater than 2, that is, the number of transmission layers is greater than 2, and the number of ports of a PT-RS is 2, the fifth indication information includes 1 bit or 2 bits.

As an example, when the fifth indication information includes 1 bit and the fourth indication information includes 2 bits, the 1 bit of the fifth indication information may be located in the middle of the 2 bits of the fourth indication information. In this case, it may be considered that 1 bit of the fifth indication information and 2 bits of the fourth indication information constitute an extended second information field. As an example, the second correspondence may be as shown in Table 8.

TABLE 8

| MSB | | | LSB | |
|---|---|---|---|---|
| state | | The fifth indication | state | |
| value | DMRS Port | information includes 1 bit | value | DMRS Port |
| 0 | The first DMRS port | State 0: PT-RS is not | 0 | The first DMRS port |
| | sharing PT-RS port 0 | present | | sharing PT-RS port 1 |
| 1 | The second DMRS port | State 1: PT-RS is present | 1 | The second DMRS port |
| | sharing PT-RS port 0 | | | sharing PT-RS port 1 |

In this example, MSB and LSB are 2 bits of the fourth indication information, and MSB corresponds to PT-RS port 0 and LSB corresponds to PT-RS port 1. When the state value of the fifth indication information is 0, it indicates that neither PT-RS port 0 nor PT-RS port 1 is present. When the state value is 1, it indicates that both PT-RS port 0 and PT-RS port 1 are present. The first spatial parameter, such as TRP1, and the second spatial parameter, such as TRP2, both use the second correspondence to determine whether the PT-RS is present. The number of ports of the PT-RS associated with each spatial parameter is 2.

As another example, when the fifth indication information is 2 bits and the fourth indication information is 2 bits, the 2 bits of the fifth indication information may be inserted between the 2 bits of the fourth indication information. In this case, it may be considered that the 2 bits of the fifth indication information and the 2 bits of the fourth indication information constitute an extended second information field. As an example, the second correspondence may be as shown in Table 9.

TABLE 9

| | | 1 bit of | | | Another bit |
|---|---|---|---|---|---|
| MSB | | the fifth | LSB | | of the fifth |
| state | | indication | state | | indication |
| value | DMRS port | information | value | DMRS port | information |
| 0 | The first | State 0: | 0 | The first | State 0: |
| | DMRS port | PT-RS is not | | DMRS port | PT-RS is not |
| | sharing PT- | present | | sharing PT- | present |
| | RS port 0 | State 1: | | RS port 1 | State 1: |
| | | PT-RS is | | | PT-RS is |
| | | present | | | present |
| 1 | Second | State 0: | 1 | Second | State 0: |
| | DMRS port | PT-RS is not | | DMRS port | PT-RS is not |
| | sharing PT- | present | | sharing PT- | present |
| | RS port 0 | State 1: | | RS port 1 | State 1: |
| | | PT-RS is | | | PT-RS is |
| | | present | | | present |

In this example, MSB and LSB are 2 bits of the fourth indication information, the MSB corresponds to the first spatial parameter, such as TRP1, and the LSB corresponds to the second spatial parameter, such as TRP2. The 2 bits of the fifth indication information are inserted between the MSB and LSB of the fourth indication information, the high 1 bit in the fifth indication information may correspond to the first spatial parameter, such as TRP1, and the low 1 bit may correspond to the second spatial parameter, such as TRP2. It can be understood that the second information field used to carry the fourth indication information and the fifth indication information includes 4 bits (B3˜B0), where B3 and B1 correspond to the MSB and LSB of the fourth indication information respectively, and B2 and B0 correspond to 2 bits of the fifth indication information. The first spatial parameter, such as TRP1, and the second spatial parameter, such as TRP2, both use the second correspondence to determine whether a PT-RS is present. The number of ports of the PT-RS associated with each spatial parameter is 2.

That is to say, the highest 2 bits of the second information field are used to indicate whether the PT-RS associated with the first spatial parameter is present when the PT-RS port p is associated with the DMRS port q; and the lowest 2 bits of the second information field are used to indicate whether the PT-RS associated with the first spatial parameter is present when the PT-RS port r is associated with the DMRS port s, where p, q, r, and s are integers. Similarly, the second spatial parameter may be indicated in the same manner.

Optionally, p=0, q=1 or 2.

Optionally, r=1, s=1 or 2.

For example, when the state value of B3 in the second information field is 0, PT-RS port 0 is associated with the first DMRS port sharing PT-RS port 0, and when the state value of B1 in the second information field is 1, the PT-RS associated with the first spatial parameter is present. When the state value of B1 in the second information field is 1, PT-RS port 1 is associated with the second DMRS port sharing PT-RS port 1, and when the state value of B0 in the second information field is 0, the PT-RS associated with the first spatial parameter is not present.

Optionally, if maxrank is less than or equal to 2, that is, the number of transmission layers is less than or equal to 2, the number of ports of each PT-RS is 1, and the fifth indication information is 2 bits. As an example, the second correspondence may be as shown in Table 10.

TABLE 10

| MSB | | Fifth | LSB | | Fifth |
|---|---|---|---|---|---|
| state | | indication | state | | indication |
| value | DMRS port | information | value | DMRS port | information |
| 0 | The first DMRS port | State 0: | 0 | The first DMRS port | State 0: |
| | associated with the | PT-RS is not | | associated with the | PT-RS is not |
| | first SRI and the first | present | | second SRI and the | present |
| | precoding information | State 1: | | second precoding | State 1: |
| | and number of layers | PT-RS is | | information and | PT-RS is |
| | field | present | | number of layers field | present |
| 1 | The second DMRS | | 1 | The second DMRS | |
| | port associated with | | | port associated with the | |
| | the first SRI and the | | | second SRI and the | |
| | first precoding | | | second precoding | |
| | information and | | | information and | |
| | number of layers field | | | number of layers field | |

In this example, MSB and LSB are 2 bits of the fourth indication information, where the MSB corresponds to the first spatial parameter, such as TRP1, and the LSB corresponds to the second spatial parameter, such as TRP2. The 2 bits of the fifth indication information are inserted between the MSB and LSB of the fourth indication information, and the high 1 bit in the fifth indication information may correspond to the first spatial parameter, such as TRP1, and the low 1 bit may correspond to the second spatial parameter, such as TRP2. That is to say, the highest 2 bits of the second information field are used to indicate whether the PT-RS associated with the first spatial parameter is present when the PT-RS port p is associated with the DMRS port q; and the lowest 2 bits of the second information field are used to indicate whether the PT-RS associated with the second spatial parameter is present when the PT-RS port r is associated with the DMRS port s, where p, q, r, and s are integers.

Optionally, p=0, q=1 or 2.

Optionally, r=1, s=1 or 2.

It should be noted that in the embodiment of the present application, the second correspondences corresponding to different spatial parameters may be the same, or may be different, that is, when determining whether PT-RSs associated with different spatial parameters are present, the terminal device may use the same table, or may use different tables.

For example, when determining whether the PT-RS associated with the first spatial parameter is present, whether the PT-RS is present may be determined based on the second information field of the first DCI in combination with the second correspondence corresponding to the first spatial parameter (for example, the correspondences shown in Table 8 to Table 10), where the first DCI is used to schedule the PUSCH associated with the first spatial parameter.

As another example, when determining whether the PT-RS associated with the second spatial parameter is present, whether the PT-RS is present may be determined based on the second information field of the second DCI in combination with the second correspondence corresponding to the second spatial parameter (for example, the correspondences shown in Table 8 to Table 10), where the second DCI is used to schedule the PUSCH associated with the second spatial parameter.

As another example, when determining whether the PT-RS associated with the first spatial parameter is present, the PT-RS may be determined based on the first second information field of the single DCI in combination with the second correspondence corresponding to the first spatial parameter (for example, the correspondences shown in Table 8 to Table 10). When determining whether the PT-RS associated with the second spatial parameter is present, the PT-RS may be determined based on the second second information field of the single DCI in combination with the second correspondence corresponding to the second spatial parameter (for example, the correspondences shown in Table 8 to Table 10), where the single DCI is used to schedule the PUSCH associated with the first spatial parameter and the PUSCH associated with the second spatial parameter.

It should be understood that when the fifth indication information is carried by other signaling, such as MAC CE or RRC signaling, the way of carrying and decoding the fifth indication information are similar to the way for carrying and decoding when the fifth indication information is carried by DCI, which will not be repeated here.

In some embodiments of the present application, S210 may include:
determining the absent PT-RS and/or present PT-RS of the at least two PT-RSs according to a first rule, where the first rule is pre-defined, or the first rule is configured by the network device.

In some embodiments, the first rule is a predefined rule or a default rule, that is, both the network device and the terminal device are capable of obtaining the first rule, which is conducive to ensuring that the terminal device and the network device have a consistent understanding of the present PT-RS and/or the absent PT-RS.

In some other embodiments, the first rule is configured by the network device, that is, the terminal device and the network device have a consistent understanding of the present PT-RS and/or the absent PT-RS.

In some embodiments, the first rule is configured by the network device via high-layer signaling, such as RRC signaling.

In some embodiments, in the case where the aforementioned fifth indication information is not received, the terminal device determines the absent PT-RS and/or the present PT-RS of at least two PT-RSs according to the first rule.

In some embodiments, the first rule includes:
that a PT-RS corresponding to a PUSCH associated with a first spatial parameter is not present; and/or,
that a PT-RS corresponding to a PUSCH associated with a second spatial parameter is present.

For example, the first spatial parameter is a spatial parameter with the smallest index among spatial parameters associated with the at least two PUSCHs. That is, the PT-RS corresponding to the PUSCH associated with the spatial parameter with the smallest index is not transmitted.

As another example, the second spatial parameter is a spatial parameter with the largest index among spatial parameters associated with the at least two PUSCHs. That is, the PT-RS corresponding to the PUSCH associated with the spatial parameter with the maximum index is transmitted.

For example, the first spatial parameter is a spatial parameter with the largest index among spatial parameters associated with the at least two PUSCHs. That is, the PT-RS corresponding to the PUSCH associated with the spatial parameter with the maximum index is not transmitted.

As another example, the second spatial parameter is a spatial parameter with the smallest index among spatial parameters associated with the at least two PUSCHs. That is, the PT-RS corresponding to the PUSCH associated with the spatial parameter of the minimum index is transmitted.

As an example, the first rule may include at least one of the following:
not transmitting a PT-RS corresponding to a PUSCH associated with a TRP with a smaller index;
not transmitting a PT-RS corresponding to a PUSCH associated with a panel with a smaller index;
not transmitting a PT-RS of the PUSCH associated with a CORESET group with a smaller index;
not transmitting a PT-RS corresponding to a PUSCH associated with a TCI state with a smaller index; or
not transmitting a PT-RS corresponding to a PUSCH associated with an SRS resource set with a smaller index.

As another example, the first rule may include at least one of the following: not transmitting a PT-R corresponding to a PUSCH associated with a TRP with a larger index;
not transmitting a PT-R corresponding to a PUSCH associated with a panel with a larger index;
not transmitting a PT-RS of the PUSCH associated with a CORESET group with a larger index;
not transmitting a PT-RS corresponding to a PUSCH associated with a TCI state with a larger index; or
not transmitting a PT-RS corresponding to a PUSCH associated with an SRS resource set with a larger index.

### Embodiment 2

In some embodiments, in the case where the at least two PUSCHs are scheduled via one PDCCH, the terminal device uses Mode 2 to transmit the at least two PUSCHs.

In some embodiments of the present application, the at least portion of the resource locations of the at least two PT-RSs being not overlapped includes:
at least portion of time domain resources of the at least two PT-RSs being not overlapped; and/or,
at least portion of frequency domain resources of the at least two PT-RSs being not overlapped.

In some embodiments, the at least portion of the time domain resources of the at least two PT-RSs being not overlapped may include:
the time domain resources of the at least two PT-RSs not overlapping at all, or a portion of the time domain resources of the at least two PT-RSs not overlapping.

For example, the at least two PT-RSs occupy different time units, or the at least two PT-RSs occupy different parts of a time unit, or the at least two PT-RSs occupy non-overlapped parts of resource locations in a time unit.

Optionally, the time unit here may be a time slot, a sub-slot or an OFDM symbol, which is not limited in the present application.

For example, the at least two PT-RSs occupy different time slots, or occupy different OFDM symbols in the same time slot.

In some embodiments, the at least portion of frequency domain resources of the at least two PT-RSs being not overlapped may include:
the frequency domain resources of the at least two PT-RSs not overlapping at all, or a portion of the frequency domain resources of the at least two PT-RSs not overlappling.

For example, the at least two PT-RSs occupy different frequency domain units, or the at least two PT-RSs occupy different parts of a frequency domain unit, or the at least two PT-RSs occupy non-overlapped parts of resource locations in a frequency domain unit.

Optionally, the frequency domain unit here may be RB, RE, or the like, which is not limited in the present application.

For example, the at least two PT-RSs occupy different RBs, or occupy different REs in the same RB.

As a specific example, the at least portion of the resource locations of the at least two PT-RSs being not overlapped includes:

RE offsets of the at least two PT-RSs being different.

In some embodiments of the present application, S210 may include:
determining the transmission mode for the at least two PT-RSs according to target indication information, where the target indication inforamtion is used to indicate transmission information of the at least two PT-RSs.

For example, the resource locations of each of the at least two PT-RSs are determined according to the target indication information, and at least portion of the resource locations of the at least two PT-RSs are determined to be not overlapping according to the target indication information.

In some embodiments, the target indication information includes at least one of the following:
first indication information used to indicate a time domain density of a PT-RS;
second indication information used to indicate a frequency domain density of a PT-RS;
third indication information used to indicate an RE offset of a PT-RS;
fourth indication information used to indicate an association between a PT-RS port and a DMRS port; or sixth indication information used to determine resource locations of the at least two PT-RSs.

It should be understood that the above-mentioned indication information may be carried in the same signaling, or may also be carried in different signaling. The present application does not limit the way of carrying indication information.

In some embodiments, the first indication information may be transmitted via high-layer signaling. For example, the high-layer signaling may include RRC signaling.

Optionally, in the case where the terminal device does not receive the first indication information, a default time domain density may be used, for example, being present once in each OFDM symbol.

In some embodiments, the second indication information may be transmitted via high-layer signaling. For example, the high-layer signaling may include RRC signaling.

Optionally, in the case where the terminal device does not receive the second indication information, a default frequency domain density may be used, for example, being present once every two RBs.

In some embodiments, the third indication information may be transmitted via high-layer signaling. For example, the high-layer signaling may include RRC signaling.

Optionally, in the case where the terminal device does not receive the third indication information, a default RE offset may be used, such as occupying sub-carrier 0.

In some embodiments, the fourth indication information may be transmitted via dynamic signaling. For example, the dynamic signaling may include DCI signaling.

In some embodiments, the first indication information is configured for the terminal device (i.e., the first indication information is configured per UE), i.e., all PT-RSs transmitted by the terminal device have the same time domain density.

In some other embodiments, the first indication information is configured for each PT-RS (i.e., the first indication information is configured per PT-RS), that is, each PT-RS has an independent time domain density.

Optionally, for a PT-RS that is present, the network device configures a corresponding time domain density, and for a PT-RS that is not present, the network device may not configure a corresponding time domain density. That is, the target indication information may only include the first indication information corresponding to the present PT-RSs.

In some embodiments, the second indication information is configured for the terminal device (i.e., the second indication information is configured per UE), i.e., all PT-RSs transmitted by the terminal device have the same frequency domain density.

In some other embodiments, the second indication information is configured for each PT-RS (i.e., the first indication information is configured per PT-RS), that is, each PT-RS has an independent offset density.

Optionally, for a PT-RS that is present, the network device configures a corresponding frequency domain density, and for a PT-RS that is not present, the network device may not configure a corresponding frequency domain density. That is, the target indication information may only include the second indication information corresponding to the present PT-RSs.

In some embodiments, the third indication information is configured for the terminal device (i.e., the third indication information is configured per UE), i.e., all PT-RSs transmitted by the terminal device have the same RE offset.

In some other embodiments, the third indication information is configured for each PT-RS (i.e., the first indication information is configured per PT-RS), that is, each PT-RS has an independent RE offset. For example, for different PT-RSs, the network device may configure different RE offsets.

In this way, in the case where the terminal device is capable of determining the resource locations of the PT-RS based on the first indication information, the second indication information and the third indication information, since the third indication information indicates different RE offsets for different PT-RSs, even if the first indication information and the second indication information are dedicated to the terminal device, it may be ensured that at least portion of the resource locations corresponding to different PT-RSs are not overlapped.

Optionally, for a PT-RS that is present, the network device configures a corresponding RE offset, and for a PT-RS that is not present, the network device may not configure a corresponding RE offset. That is, the target indication information may only include the third indication information corresponding to the present PT-RSs.

Therefore, in the embodiment of the present application, by configuring a dedicated time domain density, frequency domain density, and at least one of RE offset for each PT-RS, it is helpful to ensure that at least portion of the resource locations of each PT-RS are not overlapped.

In some embodiments, in the case where the at least two PUSCHs are associated with at least two spatial parameters and the maxrank is less than or equal to 2, the fourth indication information is carried in a PT-RS port and DMRS port association information field. In the case where the at least two PUSCHs are associated with at least two spatial parameters and the maxrank is greater than 2, the fourth indication information is carried in an at least two PT-RS ports and DMRS ports association information field.

In some embodiments, the sixth indication information is transmitted via at least one of the following signalings: DCI, RRC signaling, or a MAC CE.

It should be understood that the embodiment of the present application does not limit the way of carrying the sixth indication information in the above-mentioned signaling. For example, it may be carried in an existing information field of the signaling, or a new information field may be added, which is not limited in the present application.

In some embodiments, the at least portion of the resource locations of the at least two PT-RSs being not overlapped is determined based on the sixth indication information.

In some embodiments, the sixth indication information is used to update resource locations of some PT-RSs in the at least two PT-RSs.

In other words, when determining the resource locations of the PT-RSs, the resource locations of some PT-RSs needs to be determined according to the sixth indication information, and the way of determining resource locations of other PT-RSs in at least two PT-RSs is the same.

In some embodiments, the network device indicates the sixth indication information to the terminal device only when it is determined based on the first indication information, the second indication information, the third indication information and the fourth indication information that the resource locations of the at least two PT-RSs overlap and/or DMRS ports associated with the at least two PT-RSs are the same.

In some embodiments, the at least two PUSCHs include a first PUSCH and a second PUSCH, and that DMRS ports associated with the at least two PT-RSs are the same may include at least one of the following cases:
the number of ports of a PT-RS corresponding to the first PUSCH being 1, e.g., PT-RS port 0, the number of ports of a PT-RS corresponding to the second PUSCH being 1, e.g., PT-RS port 1, and the DMRS port associated with PT-RS port 0 being the same as the DMRS port associated with PT-RS port 1;
the number of ports of the PT-RS corresponding to the first PUSCH being 2, e.g., PT-RS ports 0 and 1, the number of ports of the PT-RS corresponding to the second PUSCH being 1, e.g., PT-RS port 2, and the DMRS port associated with PT-RS port 2 being the same as the DMRS port associated with PT-RS port 0 or 1; or
the number of ports of the PT-RS corresponding to the first PUSCH being 2, e.g., PT-RS ports 0 and 1, the number of ports of the PT-RS corresponding to the second PUSCH being 2, e.g., PT-RS port 2 and port 3, and the DMRS port associated with PT-RS port 2 or 3 being the same as the DMRS port associated with PT-RS port 0 or 1.

In some embodiments of the present application, the sixth indication information is used to indicate an additional RE offset of a PT-RS, where the additional RE offset is an additional offset relative to a reference RE offset, where the reference RE offset is indicated by the third indication information.

In some embodiments, the sixth indication information may include 1 bit or 2 bits.

In some embodiments, different state values of the sixth indication information are used to indicate different additional RE offsets.

For example, the sixth indication information include 1 bit, a state value of 0 corresponds to an additional RE offset of 1, and a state value of 1 corresponds to an additional RE offset of 2.

In some embodiments, the terminal device may determine a target RE offset of a PT-RS based on the reference RE offset indicated by the third indication information and the additional RE offset indicated by the sixth indication information.

In some embodiments, the sixth indication information is used to indicate an additional RE offset corresponding to each PT-RS of the at least two PT-RSs.

In this case, the terminal device may determine the target RE offset of each PT-RS based on the reference RE offset indicated by the third indication information and the additional RE offset of the PT-RS indicated by the sixth indication information.

In some embodiments, the sixth indication information is used to indicate additional RE offsets corresponding to a portion of PT-RSs of the at least two PT-RSs (e.g., the first PT-RS). That is, other PT-RSs (e.g., the second PT-RS) do not correspond to additional RE offsets.

In this case, the terminal device may determine the target RE offset of the first PT-RS based on the reference RE offset indicated by the third indication information and the additional RE offset of the first PT-RS indicated by the sixth indication information. The reference RE offset indicated by the third indication information is determined as the target RE offset of the second PT-RS.

As an implementation, if the additional RE offset of the PT-RS indicated by the sixth indication information is w, and the reference RE offset of the PT-RS indicated by the third indication information is t, then the target RE offset of the PT-RS may be (t+w) mod (12), where mod denotes a modulo operation.

In some other embodiments of the present application, the sixth indication information is used to indicate an additional RE offset associated with a spatial parameter.

For example, the additional RE offset associated with the first spatial parameter is a first additional RE offset, and the additional RE offset associated with the second spatial parameter is a second additional RE offset. The first spatial parameter and the second spatial parameter are different, the first additional RE offset and the second additional RE offset are non-negative integers, and the first additional RE offset and the second additional RE offset are different.

In some embodiments, the index of the first spatial parameter is less than the index of the second spatial parameter.

That is, the first spatial parameter is a spatial parameter with a smaller index, and the second spatial parameter is a spatial parameter with a larger index.

In some embodiments, both the first additional RE offset and the second additional RE offset are not zero and not equal.

In some other embodiments, the first additional RE offset is zero and the second additional RE offset is not zero, or the second additional RE offset is zero and the first additional RE offset is not zero. That is, a portion of PT-RSs of the at least two PT-RSs may not correspond to an additional RE offset, or in other words, the RE offsets of a portion of PT-RSs are determined according to the reference RE offset indicated by the third indication information.

For example, a PT-RS corresponding to a PUSCH associated with a spatial parameter with a smaller index does not correspond to an additional RE offset.

In some embodiments of the present application, the terminal device may determine an additional RE offset corresponding to each PT-RS of the at least two PT-RSs based on the spatial parameters associated with the at least two PUSCHs in combination with the sixth indication information, and further determine the target RE offset of each PT-RS in combination with the reference RE offset indicated by the third indication information.

For example, the at least two PUSCHs include a first PUSCH and a second PUSCH, the first PUSCH is associated with a first spatial parameter, and the second PUSCH is associated with a second spatial parameter. It may be determined that the additional RE offset of the PT-RS corresponding to the first PUSCH is a first additional RE offset, and the additional RE offset of the PT-RS corresponding to the second PUSCH is a second additional RE offset.

Further, a target RE offset of a PT-RS corresponding to the first PUSCH is determined according to the first additional RE offset and the reference RE offset, and a target RE offset of a PT-RS corresponding to the second PUSCH is determined according to the second additional RE offset and the reference RE offset.

In summary, the terminal device may determine the RE offsets corresponding to the at least two PT-RSs according to the third indication information and the sixth indication information.

In some other embodiments of the present application, the terminal device may also determine the RE offsets corresponding to the at least two PT-RSs according to the third indication information and the fourth indication information.

For example, according to the third indication information and the fourth indication information, in combination with at least two correspondences, DMRS ports respectively associated with ports of the at least two PT-RSs and RE offsets of the at least two PT-RSs are determined, where each of the at least two correspondences is used to determine an RE offset mapped by a port of the PT-RS on an associated DMRS port;
where in the at least two correspondences, for third indication information and fourth indication information with a same state value, the at least two PT-RSs are associated with different DMRS ports, and/or RE offsets mapped by the at least two PT-RSs are different.

Therefore, when determining the RE offsets of the at least two PT-RS ports on the associated DMRS ports based on the state values of the third indication information and the fourth indication information, even if the third indication information and the fourth indication information are dedicated to the terminal device, that is, all PT-RSs use the same third indication information and fourth indication information, for different PT-RSs, the terminal device determines the RE offset on an associated DMRS port based on different correspondences, and in different correspondences, third indication information and fourth indication information with the same state value correspond to different RE offsets, which is conducive to ensuring that different PT-RS are mapped to different RE offsets on the same DMRS port, thereby avoiding the conflict problem of PT-RSs.

It should be understood that in the embodiment of the present application, since each PT-RS is associated with a spatial parameter, each correspondence corresponding to a PT-RS may also be replaced by each correspondence corresponding to a spatial parameter, or each correspondence being associated with a spatial parameter. That is, for a PT-RS corresponding to a PUSCH associated with a spatial parameter, the RE offset mapped by the PT-RS on the DMRS port may be determined according to the correspondence associated with the spatial parameter.

In some embodiments, the above at least two correspondences may be pre-defined, or may be configured by the network device, or may be generated according to a preset rule, for example, by adjusting the correspondence shown in Table 3.

In some embodiments, the at least two correspondences may include the above correspondence shown in Table 3, and at least one correspondence generated by adjusting the correspondence shown in Table 3.

For example, by adjusting a row of RE offsets corresponding to a DMRS port in Table 3 (i.e., a row of RE offsets corresponding to a DMRS port may be adjusted), and/or by adjusting the correspondence between state values of the third indication information and a column of RE offsets in Table 3 (i.e., a column of RE offsets corresponding to the state values of the third indication information may be adjusted), a new correspondence is obtained.

As an example, the at least two correspondences comprise a third correspondence and a fourth correspondence, where an RE offset corresponding to a DMRS port j in the third correspondence is the same as an RE offset corresponding to a DMRS port i in the fourth correspondence, and i and j are integers and different.

For example, the third correspondence may be the correspondence in Table 3, the fourth correspondence may be the correspondence in Table 11, and the fourth correspondence may be obtained by shifting a row of RE offsets corresponding to a DMRS port in Table 3 upward by one row, where the first row of RE offsets in Table 3 may be shifted to the last row in the correspondence list.

It should be understood that in the embodiment of the present application, the adjustment of the correspondence in Table 3 is an adjustment of the correspondence between the DRMS port and the RE offset under the same DMRS configuration type.

TABLE 11

| | RE offset | | | | | | | |
|---|---|---|---|---|---|---|---|---|
| | DM-RS configuration type 1 | | | | DM-RS configuration type 2 | | | |
| | resourceElementOffset | | | | resourceElementOffset | | | |
| DMRS | State | State | State | State | State | State | State | State |
| Port \tilde{p} | 00 | 01 | 10 | 11 | 00 | 01 | 10 | 11 |
| 0 | 2 | 4 | 8 | 10 | 1 | 6 | 7 | 0 |
| 1 | 1 | 3 | 7 | 9 | 2 | 3 | 8 | 9 |
| 2 | 3 | 5 | 9 | 11 | 3 | 8 | 9 | 2 |
| 3 | 0 | 2 | 6 | 8 | 4 | 5 | 10 | 11 |
| 4 | — | — | — | — | 5 | 10 | 11 | 4 |
| 5 | — | — | — | — | 0 | 1 | 6 | 7 |

For example, Table 3 corresponds to the first spatial parameter, Table 11 corresponds to the second spatial parameter, the at least two PUSCHs include a first PUSCH and a second PUSCH, which are respectively associated with the first spatial parameter and the second spatial parameter. For PT-RSs corresponding to PUSCHs associated with different spatial parameters, when determining the RE offsets mapped by the PT-RSs on the MDRS port, tables associated with different spatial parameters are used.

For example, if the state of the third indication information is 00 and the state value of the fourth indication information is 0, then it is determined that a port of the PT-RS corresponding to the first PUSCH is associated DMRS port 0 according to the state value of the fourth indication information, and that the PT-RS corresponding to the first PUSCH is mapped to sub-carrier 0 of DMRS port 0 according to the state value of the third indication information in combination with Table 3, and that a port of the PT-RS corresponding to the second PUSCH is associated DMRS port 0 according to the state value of the fourth indication information, and that the PT-RS corresponding to the second PUSCH is mapped to sub-carrier 2 of DMRS port 0 according to the state value of the third indication information in combination with Table 10, that is, the PT-RS corresponding to the first PUSCH and the PT-RS corresponding to the second PUSCH are not overlapped.

As another example, the at least two correspondences include a fifth correspondence and a sixth correspondence, where in the fifth correspondence and the sixth correspondence, the same DMRS port and the same state value of the third indication information correspond to different RE offsets.

That is to say, in different correspondences, under the same DMRS port, the same RE offset corresponds to different state values of the third indication information.

For example, the fifth correspondence may be the correspondence shown in Table 3, and the sixth correspondence may be the correspondence shown in Table 12, where the correspondence shown in Table 12 may be obtained by shifting one column to the right a column of RE offsets corresponding to the state value of the third indication information in Table 3, where the last column of RE offsets in Table 3 may be shifted to the first column in the correspondence list (for the same DMRS configuration type).

It should be understood that in the embodiment of the present application, the adjustment of the correspondence shown in Table 3 is the adjustment of the correspondence between the state value of the third indication information and the RE offset under the same DMRS configuration type.

TABLE 12

| | RE offset | | | | | | | |
|---|---|---|---|---|---|---|---|---|
| | DM-RS configuration type 1 | | | | DM-RS configuration type 2 | | | |
| | resourceElementOffset | | | | resourceElementOffset | | | |
| DMRS | State | State | State | State | State | State | State | State |
| Port \tilde{p} | 00 | 01 | 10 | 11 | 00 | 01 | 10 | 11 |
| 0 | 8 | 0 | 2 | 6 | 7 | 0 | 1 | 6 |
| 1 | 10 | 2 | 4 | 8 | 0 | 1 | 6 | 7 |
| 2 | 9 | 1 | 3 | 7 | 9 | 2 | 3 | 8 |
| 3 | 11 | 3 | 5 | 9 | 2 | 3 | 8 | 9 |
| 4 | — | — | — | — | 11 | 4 | 5 | 10 |
| 5 | — | — | — | — | 4 | 5 | 10 | 11 |

For example, Table 3 corresponds to the first spatial parameter, Table 12 corresponds to the second spatial parameter, the at least two PUSCHs include a first PUSCH and a second PUSCH, which are respectively associated with the first spatial parameter and the second spatial parameter. For PT-RSs corresponding to PUSCHs associated with different spatial parameters, when determining the RE offsets mapped by the PT-RSs on the MDRS port, tables associated with different spatial parameters are used.

For example, if the state of the third indication information is 00 and the state value of the fourth indication information is 0, then it is determined that a port of the PT-RS corresponding to the first PUSCH is associated DMRS port 0 according to the state value of the fourth indication information, and that the PT-RS corresponding to the first PUSCH is mapped to sub-carrier 0 of DMRS port 0 according to the state value of the third indication information in combination with Table 3, and that a port of the PT-RS corresponding to the second PUSCH is associated DMRS port 0 according to the state value of the fourth indication information, and that the PT-RS corresponding to the second PUSCH is mapped to sub-carrier 8 of DMRS port 0 according to the state value of the third indication information in combination with Table 11, that is, the PT-RS corresponding to the first PUSCH and the PT-RS corresponding to the second PUSCH are not overlapped.

In some other embodiments of the present application, S210 includes:
determining at least portion of the resource locations of the at least two PT-RSs being not overlapped according to a second rule, where the second rule is pre-defined, or the second rule is configured by a network device.

In some embodiments, the second rule is a predefined rule or a default rule, that is, both the network device and the terminal device are capable of obtaining the second rule, and the terminal device and the network device use the same rule to determine the resource locations of the at least two PT-RS, which is conducive to ensuring that the terminal device and the network device have a consistent understanding of the resource locations of the at least two PT-RS.

In other embodiments, the second rule is configured by the network device. The terminal device and the network device use the same rule to determine the resource locations of the at least two PT-RSs, which is conducive to ensuring that the terminal device and the network device have a consistent understanding of the resource locations of the at least two PT-RSs

In some embodiments, the second rule is configured by the network device via high-layer signaling, such as RRC signaling.

In some embodiments, in the case where the aforementioned sixth indication information is not received, the terminal device determines the resource locations of the at least two PT-RSs according to the second rule.

In some embodiments, the determining the at least portion of the resource locations of the at least two PT-RSs being not overlapped according to the second rule includes:
determining that the at least two PT-RSs correspond to different RE offsets according to the second rule.

In some embodiments, the second rule includes:
an RE offset of a PT-RS corresponding to a PUSCH associated with a third spatial parameter being a third additional RE offset; and/or
an RE offset of a PT-RS corresponding to a PUSCH associated with a fourth spatial parameter being a fourth additional RE offset;
where the third spatial parameter and the fourth spatial parameter are different, the third additional RE offset and the fourth additional RE offset are different, and the third additional RE offset and the fourth additional RE offset are non-negative integers.

In some embodiments, both the third additional RE offset and the fourth additional RE offset are not zero.

For example, the at least two PUSCHs include a third PUSCH and a third PUSCH, the third PUSCH is associated with a third spatial parameter, and the third PUSCH is associated with a third spatial parameter. Thus, it may be determined that the additional RE offset of the PT-RS corresponding to the third PUSCH is the third additional RE offset, and the additional RE offset of the PT-RS corresponding to the fourth PUSCH is the fourth additional RE offset.

Further, the terminal device may determine the target RE offset of the PT-RS corresponding to the third PUSCH based on the third additional RE offset and the reference RE offset indicated by the third indication information, and may determine the target RE offset of the PT-RS corresponding to the fourth PUSCH based on the fourth additional RE offset and the reference RE offset indicated by the third indication information.

In some embodiments, the third additional RE offset is zero and the fourth additional RE offset is not zero.

For example, the at least two PUSCHs include a third PUSCH and a fourth PUSCH, the third PUSCH is associated with a third spatial parameter, and the third PUSCH is associated with a third spatial parameter. It may be determined that the additional RE offset of the PT-RS corresponding to the third PUSCH is 0, and the additional RE offset of the PT-RS corresponding to the fourth PUSCH is the fourth additional RE offset.

Further, the terminal device may determine the reference RE offset indicated by the third indication information as the target RE offset of the PT-RS corresponding to the third PUSCH, and may determine the target RE offset of the PT-RS corresponding to the fourth PUSCH based on the fourth additional RE offset and the reference RE offset indicated by the third indication information.

In some embodiments, the third additional RE offset is x, the fourth additional RE offset is y, and y=(x+R) mod (12), where R is any positive integer, and mod denotes a modulo operation.

Optionally, R may be a random positive integer.

In some embodiments, x is 0.

In some embodiments, an index of the third spatial parameter is less than an index of the fourth spatial parameter.

For example, a PT-RS corresponding to a PUSCH associated with a spatial parameter with a smaller index does not correspond to an additional RE offset. In this case, the terminal device determines the reference RE offset indicated by the third indication information as the target RE offset of the PT-RS corresponding to the PUSCH associated with the third spatial parameter.

It should be noted that in the embodiments of the present application, the above-mentioned Embodiment 1 and Embodiment 2 may be implemented independently, or may be implemented in combination, which is not limited in the present application.

In some embodiments, the target indication information may include at least one of the following:
first indication information, used to indicate a time domain density of a PT-RS;
second indication information, used to indicate a frequency domain density of a PT-RS;
third indication information, used to indicate an RE offset of a PT-RS;
fourth indication information, used to indicate an association between a PT-RS port and a DMRS port; or
sixth indication information, used to determine resource locations of the at least two PT-RSs.

For example, in the case where the target indication information includes the fifth indication information but does not include the sixth indication information, the at least two PUSCHs are transmitted according to the mode described in Example 1, that is, the PT-RSs corresponding to a portion of PUSCHs of the at least two PUSCHs are not transmitted.

As another example, in the case where the target indication information includes the sixth indication information but does not include the fifth indication information, the at least two PUSCHs are transmitted according to the method described in Example 2, that is, at least portion of the resource locations of the PT-RSs corresponding to the at least two PUSCHs are not overlapped.

As another example, in the case where the target indication information includes the sixth indication information and the fifth indication information, the at least two PUSCHs are transmitted according to the modes described in Examples 1 and 2, that is, the PT-RSs corresponding to a portion of PUSCHs of the at least two PUSCHs are not transmitted, and/or at least portion of the resource locations of other PT-RSs in at least two PUSCHs are not overlapped.

In summary, in the embodiments of the present application, the terminal device avoids the conflict problem of PT-RSs corresponding to at least two PUSCHs by not transmitting a portion of PT-RSs of the at least two PT-RSs and/or by transmitting at least two PT-RSs that are at least partially not overlapped, which may further avoid the degradation of the common phase error compensation performance and is conducive to reducing the interference caused by the power boost of PT-RSs.

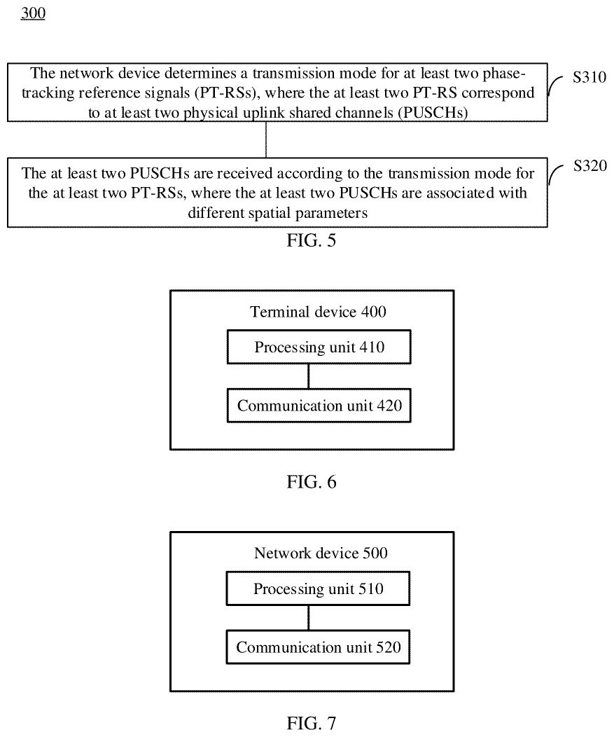

With reference to FIGS. 2 to 4, a method for wireless communication according to an embodiment of the present application from the perspective of the terminal device is described in detail in the above. In the following, a method for wireless communication according to another embodiment of the present application from the perspective of the network device will be described in detail with reference to FIG. 5. It should be understood that the description on the network device side corresponds to the description on the terminal device side, and reference may be made to similar descriptions in the above, which will not be repeated here for avoiding repetition.

FIG. 5 is a schematic flowchart of a method 300 for wireless communication according to another embodiment of the present application. The method 300 may be performed by a network device in the communication system shown in FIG. 1. As shown in FIG. 5, the method 300 includes the following contents.

In S310, the network device determines a transmission mode for at least two phase-tracking reference signals (PT-RSs), where the at least two PT-RS correspond to at least two physical uplink shared channels (PUSCHs).

In S320, the at least two PUSCHs are received according to the transmission mode for the at least two PT-RSs, where the at least two PUSCHs are associated with different spatial parameters.

The transmission mode for the at least two PT-RSs includes at least one of the following:
a portion of PT-RSs of the at least two PT-RSs being not transmitted; or at least portion of resource locations of the at least two PT-RSs being not overlapped.

It should be understood that, in method 300, the implementation of determining the transmission mode for the at least two PT-RSs on the network device side is similar to the implementation of determining the transmission mode for the at least two PT-RSs on the terminal device side, and the specific implementations may be referred to the relevant description in method 200, which will not be repeated here for brevity.

In some embodiments, the at least portion of the resource locations of the at least two PT-RSs being not overlapped includes RE offsets of the at least two PT-RSs being different.

In some embodiments, S310 may include:
determining the transmission mode for the at least two PT-RSs according to target indication information, where the target indication information is used to indicate transmission information of the at least two PT-RSs.

In some embodiments, the target indication information includes at least one of: first indication information, used to indicate a time domain density of a PT-RS; second indication information, used to indicate a frequency domain density of a PT-RS;
third indication information, used to indicate a resource element (RE) offset of a PT-RS;
fourth indication information, used to indicate an association between a PT-RS port and a demodulation reference signal (DMRS) port; or
fifth indication information, used to indicate whether a PT-RS is present.

In some embodiments, the target indication information includes one fifth indication information, and the fifth indication information is used to indicate whether each PT-RS of the at least two PT-RSs is present; or
the target indication information includes at least two fifth indication information, and each of the at least two fifth indication information corresponds to one PT-RS of the at least two PT-RSs and is used to indicate whether the corresponding PT-RS is present.

In some embodiments, the fifth indication information is carried in at least one of following signalings:
downlink control information (DCI), radio resource control (RRC), or a media access control control element (MAC CE).

In some embodiments, the fifth indication information is carried in a first information field of DCI, and the first information field is dedicated to indicating whether a PT-RS is present.

In some embodiments, different state values of the fifth indication information are used to indicate that the PT-RS is present and that the PT-RS is not present.

In some embodiments, the determining the transmission mode for the at least two PT-RSs according to the target indication information includes:
determining an absent PT-RS and/or a present PT-RS of the at least two PT-RSs according to the fifth indication information.

In some embodiments, the determining the absent PT-RS and/or the present PT-RS of the at least two PT-RSs according to the fifth indication information includes:
determining, according to the fifth indication information in combination with a first correspondence, the absent PT-RS and/or the present PT-RS of the at least two PT-RSs, where the first correspondence is used to indicate a correspondence between a state value of the fifth indication information and a situation about whether a PT-RS is present.

In some embodiments, the determining the transmission mode for the at least two PT-RSs according to the target indication information includes:
determining the absent PT-RS and/or the present PT-RS of the at least two PT-RSs according to the fourth indication information in combination with the fifth indication information.

In some embodiments, the determining the absent PT-RS and/or the present PT-RS of the at least two PT-RSs according to the fourth indication information in combination with the fifth indication information includes:
determining, according to the fourth indication information and the fifth indication information, in combination with a second correspondence, the absent PT-RS and/or the present PT-RS of the at least two PT-RSs, where the second correspondence is used to indicate a correspondence between a state value of the fourth indication information and a DMRS port and a correspondence between a state value of the fifth indication information under the DMRS port and a situation about whether a PT-RS is present.

In some embodiments, the determining, by the network device, the transmission mode for the at least two phase-tracking reference signals (PT-RSs) includes:
determining an absent PT-RS and/or a present PT-RS of the at least two PT-RSs according to a first rule, where the first rule is pre-defined, or the first rule is configured by a network device.

In some embodiments, the determining the absent PT-RS and/or the present PT-RS of the at least two PT-RSs according to the first rule includes:
in a case where fifth indication information is not received, determining the absent PT-RS and/or the present PT-RS of the at least two PT-RSs according to the first rule, where the fifth indication information is used to indicate whether a PT-RS is present.

In some embodiments, the first fule includes:
a PT-RS corresponding to a PUSCH associated with a first spatial parameter being not present.

In some embodiments, the first spatial parameter is a spatial parameter with a smallest index among spatial parameters associated with the at least two PUSCHs.

In some embodiments, the at least two PUSCHs are scheduled via at least two physical downlink control channels (PDCCHs).

In some embodiments, the target indication information includes at least one of: first indication information, used to indicate a time domain density of a PT-RS; second indication information, used to indicate a frequency domain density of a PT-RS;
third indication information, used to indicate an RE offset of a PT-RS;
fourth indication information, used to indicate an association between a PT-RS port and a DMRS port; or
sixth indication information, used to determine resource locations of the at least two PT-RSs.

In some embodiments, the sixth indication information is used to indicate an additional RE offset of a PT-RS, and the additional RE offset is an additional offset relative to a reference RE offset; where the reference RE offset is indicated by the third indication information.

In some embodiments, the additional RE offset of the PT-RS indicated by the sixth indication information is w, the reference RE offset of the PT-RS indicated by the third indication information is t, and a target RE offset of the PT-RS is (t+w) mod (12), where mod denotes a modulo operation.

In some embodiments, the sixth indication information is used to indicate an additional RE offset associated with a spatial parameter.

In some embodiments, an additional RE offset associated with a first spatial parameter is a first additional RE offset, and an additional RE offset associated with a second spatial parameter is a second additional RE offset; where the first spatial parameter and the second spatial parameter are different, the first additional RE offset and the second additional RE offset are non-negative integers, and the first additional RE offset and the second additional RE offset are different.

In some embodiments, an index of the first spatial parameter is less than an index of the second spatial parameter.

In some embodiments, the sixth indication information is used to indicate an additional RE offset corresponding to each PT-RS of the at least two PT-RSs; or the sixth indication information is used to indicate additional RE offsets corresponding to a portion of PT-RSs of the at least two PT-RSs.

In some embodiments, different state values of the sixth indication information are used to indicate different additional RE offsets.

In some embodiments, the sixth indication information is carried in at least one of following signalings: DCI, RRC, a MAC CE.

In some embodiments, the determining the transmission mode for the at least two PT-RSs according to the target indication information includes:
determining, according to the third indication information and the fourth indication information in combination with at least two correspondences, DMRS ports respectively associated with ports of the at least two PT-RSs and RE offsets of the at least two PT-RSs, where each of the at least two correspondences corresponds to a PT-RS, and the each of the at least two correspondences is used to determine an RE offset mapped by a port of the PT-RS on an associated DMRS port;
where in the at least two correspondences, for third indication information and fourth indication information with a same state value, the at least two PT-RSs are associated with different DMRS ports, and/or RE offsets mapped by the at least two PT-RSs are different.

In some embodiments, the at least two correspondences include a third correspondence and a fourth correspondence, where an RE offset corresponding to a DMRS port j in the third correspondence is same as an RE offset corresponding to a DMRS port i in the fourth correspondence, and i and j are integers and different.

In some embodiments, the at least two correspondences include a fifth correspondence and a sixth correspondence, where in the fifth correspondence and the sixth correspondence, a same DMRS port and a same state value of the third indication information correspond to different RE offsets.

In some embodiments, the determining, by the network device, the transmission mode for the at least two phase-tracking reference signals (PT-RSs) includes:
determining at least portion of the resource locations of the at least two PT-RSs being not overlapped according to a second rule, where the second rule is pre-defined, or the second rule is configured by a network device.

In some embodiments, the determining the at least portion of the resource locations of the at least two PT-RSs being not overlapped according to the second rule includes:
determining that the at least two PT-RSs correspond to different RE offsets according to the second rule.

In some embodiments, the second rule includes:
an RE offset of a PT-RS corresponding to a PUSCH associated with a third spatial parameter being a third additional RE offset; and/or
an RE offset of a PT-RS corresponding to a PUSCH associated with a fourth spatial parameter being a fourth additional RE offset;
where the third spatial parameter and the fourth spatial parameter are different, the third additional RE offset and the fourth additional RE offset are different, and the third additional RE offset and the fourth additional RE offset are non-negative integers.

In some embodiments, the third additional RE offset is x, and the fourth additional RE offset is y, y=(x+R) mod (12); where R is any positive integer, and mod denotes a modulo operation.

In some embodiments, x is 0.

In some embodiments, an index of the third spatial parameter is less than an index of the fourth spatial parameter.

In some embodiments, the at least two PUSCHs are scheduled via a same PDCCH.

In some embodiments, the first indication information is indicated per PT-RS; and/or the second indication information is indicated per PT-RS; and/or the third indication information is indicated per PT-RS.

In some embodiments, the spatial parameters includes at least one of: transmission configuration indicator (TCI) state information, antenna panel information, transmission reception point (TRP) information, control resource set (CORESET) group information, reference signal set information, reference signal information, beam information, or capability set information.

In some embodiments, the capability set information includes at least one of:
a maximum number of sounding reference signal (SRS) ports, a maximum number of uplink transmission layers, a codebook subset type, an uplink full-power transmission mode, an SRS antenna switching capability, an SRS carrier switching capability, a number of SRS resources transmitted simultaneously, a maximum modulation mode for uplink data transmission, and a maximum modulation mode for downlink data transmission.

With reference to FIGS. 2 to 5, the method embodiments of the present application are described in detail in the above. In the following, the device embodiments of the present application will be described in detail with reference to FIGS. 6 to 10. It should be understood that the device embodiments correspond to the method embodiments, and the device embodiments may refer the similar description in the method embodiments.

FIG. 6 shows a schematic block diagram of a terminal device 400 according to an embodiment of the present application. As shown in FIG. 6, the terminal device 400 includes:
a processing unit 410, configured to determine a transmission mode for at least two phase tracking reference signals (PT-RSs), where the at least two PT-RS correspond to at least two physical uplink shared channels (PUSCHs); and
a communication unit 420, configured to transmit the at least two PUSCHs according to the transmission mode for the at least two PT-RSs, where the at least two PUSCHs are associated with different spatial parameters;
where the transmission mode for the at least two PT-RSs includes at least one of the following:
a portion of PT-RSs of the at least two PT-RSs being not transmitted; or
at least portion of resource locations of the at least two PT-RSs being not overlapped.

In some embodiments, the at least portion of the resource locations of the at least two PT-RSs being not overlapped comprises RE offsets of the at least two PT-RSs being different.

In some embodiments, the processing unit 410 is further configured to:
determine the transmission mode for the at least two PT-RSs according to target indication information, where the target indication information is used to indicate transmission information of the at least two PT-RSs.

In some embodiments, the target indication information includes at least one of:
first indication information, used to indicate a time domain density of a PT-RS;
second indication information, used to indicate a frequency domain density of a PT-RS;
third indication information, used to indicate a resource element (RE) offset of a PT-RS;
fourth indication information, used to indicate an association between a PT-RS port and a demodulation reference signal (DMRS) port; or
fifth indication information, used to indicate whether a PT-RS is present.

In some embodiments, the target indication information includes one fifth indication information, and the fifth indication information is used to indicate whether each PT-RS of the at least two PT-RSs is present; or
the target indication information includes at least two fifth indication information, and each of the at least two fifth indication information corresponds to one PT-RS of the at least two PT-RSs and is used to indicate whether the corresponding PT-RS is present.

In some embodiments, the fifth indication information is carried in at least one of following signalings:
downlink control information (DCI), radio resource control (RRC), or a media access control control element (MAC CE).

In some embodiments, the fifth indication information is carried in a first information field of DCI, and the first information field is dedicated to indicating whether a PT-RS is present.

In some embodiments, different state values of the fifth indication information are used to indicate that the PT-RS is present and that the PT-RS is not present.

In some embodiments, the processing unit 410 is further configured to:
determine an absent PT-RS and/or a present PT-RS of the at least two PT-RSs according to the fifth indication information.

In some embodiments, the processing unit 410 is further configured to determine, according to the fifth indication information in combination with a first correspondence, the absent PT-RS and/or the present PT-RS of the at least two PT-RSs, where the first correspondence is used to indicate a correspondence between a state value of the fifth indication information and a situation about whether a PT-RS is present.

In some embodiments, the processing unit 410 is further configured to:
determine the absent PT-RS and/or the present PT-RS of the at least two PT-RSs according to the fourth indication information in combination with the fifth indication information.

In some embodiments, the processing unit 410 is further configured to:
determine, according to the fourth indication information and the fifth indication information, in combination with a second correspondence, the absent PT-RS and/or the present PT-RS of the at least two PT-RSs, where the second correspondence is used to indicate a correspondence between a state value of the fourth indication information and a DMRS port and a correspondence between a state value of the fifth indication information under the DMRS port and a situation about whether a PT-RS is present.

In some embodiments, the processing unit 410 is further configured to:
determine an absent PT-RS and/or a present PT-RS of the at least two PT-RSs according to a first rule, where the first rule is pre-defined, or the first rule is configured by a network device.

In some embodiments, the processing unit 410 is further configured to:
in a case where fifth indication information is not received, determine the absent PT-RS and/or the present PT-RS of the at least two PT-RSs according to the first rule, where the fifth indication information is used to indicate whether a PT-RS is present.

In some embodiments, the first fule includes a PT-RS on a PUSCH associated with a first spatial parameter being not present.

In some embodiments, the first spatial parameter is a spatial parameter with a smallest index among spatial parameters associated with the at least two PUSCHs.

In some embodiments, the at least two PUSCHs are scheduled via at least two physical downlink control channels (PDCCHs).

In some embodiments, the target indication information includes at least one of:
first indication information, used to indicate a time domain density of a PT-RS;
second indication information, used to indicate a frequency domain density of a PT-RS;
third indication information, used to indicate an RE offset of a PT-RS;
fourth indication information, used to indicate an association between a PT-RS port and a DMRS port; or
sixth indication information, used to determine resource locations of the at least two PT-RSs.

In some embodiments, the sixth indication information is used to indicate an additional RE offset of a PT-RS, and the additional RE offset is an additional offset relative to a reference RE offset, where the reference RE offset is indicated by the third indication information.

In some embodiments, the additional RE offset of the PT-RS indicated by the sixth indication information is w, the reference RE offset of the PT-RS indicated by the third indication information is t, and a target RE offset of the PT-RS is (t+w) mod (12), where mod denotes a modulo operation.

In some embodiments, the sixth indication information is used to indicate an additional RE offset associated with a spatial parameter.

In some embodiments, an additional RE offset associated with a first spatial parameter is a first additional RE offset, and an additional RE offset associated with a second spatial parameter is a second additional RE offset; where the first spatial parameter and the second spatial parameter are different, the first additional RE offset and the second additional RE offset are non-negative integers, and the first additional RE offset and the second additional RE offset are different.

In some embodiments, an index of the first spatial parameter is less than an index of the second spatial parameter.

In some embodiments, different state values of the sixth indication information are used to indicate different additional RE offsets.

In some embodiments, the sixth indication information is used to indicate an additional RE offset corresponding to each PT-RS of the at least two PT-RSs; or the sixth indication information is used to indicate additional RE offsets corresponding to a portion of PT-RSs of the at least two PT-RSs.

In some embodiments, the sixth indication information is carried in at least one of following signalings: DCI, RRC, a MAC CE.

In some embodiments, the processing unit 410 is further configured to:
determine, according to the third indication information and the fourth indication information in combination with at least two correspondences, DMRS ports respectively associated with ports of the at least two PT-RSs and RE offsets of the at least two PT-RSs, where each of the at least two correspondences corresponds to a PT-RS, and the each of the at least two correspondences is used to determine an RE offset mapped by a port of the PT-RS on an associated DMRS port;
where in the at least two correspondences, for third indication information and fourth indication information with a same state value, the at least two PT-RSs are associated with different DMRS ports, and/or RE offsets mapped by the at least two PT-RSs are different.

In some embodiments, the at least two correspondences include a third correspondence and a fourth correspondence, where an RE offset corresponding to a DMRS port j in the third correspondence is same as an RE offset corresponding to a DMRS port i in the fourth correspondence, and i and j are integers and different.

In some embodiments, the at least two correspondences include a fifth correspondence and a sixth correspondence, where in the fifth correspondence and the sixth correspondence, a same DMRS port and a same state value of the third indication information correspond to different RE offsets.

In some embodiments, the processing unit 410 is further configured to:
determine at least portion of the resource locations of the at least two PT-RSs being not overlapped according to a second rule, where the second rule is pre-defined, or the second rule is configured by a network device.

In some embodiments, the processing unit 410 is further configured to:
determine that the at least two PT-RSs correspond to different RE offsets according to the second rule.

In some embodiments, the second rule includes:
an RE offset of a PT-RS corresponding to a PUSCH associated with a third spatial parameter being a third additional RE offset; and/or
an RE offset of a PT-RS corresponding to a PUSCH associated with a fourth spatial parameter being a fourth additional RE offset;
where the third spatial parameter and the fourth spatial parameter are different, the third additional RE offset and the fourth additional RE offset are different, and the third additional RE offset and the fourth additional RE offset are non-negative integers.

In some embodiments, the third additional RE offset is x, and the fourth additional RE offset is y, y=(x+R) mod (12); where R is any positive integer, and mod denotes a modulo operation.

In some embodiments, x is 0.

In some embodiments, an index of the third spatial parameter is less than an index of the fourth spatial parameter.

In some embodiments, the at least two PUSCHs are scheduled via a same PDCCH.

In some embodiments, the first indication information is indicated per PT-RS; and/or the second indication information is indicated per PT-RS; and/or the third indication information is indicated per PT-RS.

In some embodiments, the spatial parameters includes at least one of:
transmission configuration indicator (TCI) state information, antenna panel information, transmission reception point (TRP) information, control resource set (CORESET) group information, reference signal set information, reference signal information, beam information, or capability set information.

In some embodiments, the capability set information includes at least one of:
a maximum number of sounding reference signal (SRS) ports, a maximum number of uplink transmission layers, a codebook subset type, an uplink full-power transmission mode, an SRS antenna switching capability, an SRS carrier switching capability, a number of SRS resources transmitted simultaneously, a maximum modulation mode for uplink data transmission, and a maximum modulation mode for downlink data transmission.

Optionally, in some embodiments, the above-mentioned communication unit may be a communication interface or a transceiver, or an input/output interface of a communication chip or a system on chip. The above-mentioned processing unit may be singular or plural.

It should be understood that the terminal device 400 according to embodiments of the present application may correspond to the terminal device in the method embodiments of the present application, and the above-mentioned and other operations and/or functions of various units in the terminal device 400 are for implementing corresponding processes of the network device in the method 200 shown in FIG. 4, and will not be repeated herein for brevity.

FIG. 7 is a schematic block diagram of a network device according to an embodiment of the present application. The network device 500 shown in FIG. 7 includes:
a processing unit 510, configured to determine a transmission mode for at least two phase tracking reference signals (PT-RSs), where the at least two PT-RS correspond to at least two physical uplink shared channels (PUSCHs); and
a communication unit 520, configured to receive the at least two PUSCHs according to the transmission mode for the at least two PT-RSs, where the at least two PUSCHs are associated with different spatial parameters;
where the transmission mode for the at least two PT-RSs includes at least one of:
a portion of PT-RSs of the at least two PT-RSs being not transmitted; or
at least portion of resource locations of the at least two PT-RSs being not overlapped. In some embodiments, the at least portion of the resource locations of the at least two PT-RSs being not overlapped includes RE offsets of the at least two PT-RSs being different.

In some embodiments, the processing unit 510 is further configured to:
determine the transmission mode for the at least two PT-RSs according to target indication information, where the target indication information is used to indicate transmission information of the at least two PT-RSs.

In some embodiments, the target indication information includes at least one of:
first indication information, used to indicate a time domain density of a PT-RS;
second indication information, used to indicate a frequency domain density of a PT-RS;
third indication information, used to indicate a resource element (RE) offset of a PT-RS;
fourth indication information, used to indicate an association between a PT-RS port and a demodulation reference signal (DMRS) port; or
fifth indication information, used to indicate whether a PT-RS is present.

In some embodiments, the target indication information includes one fifth indication information, and the fifth indication information is used to indicate whether each PT-RS of the at least two PT-RSs is present; or
the target indication information includes at least two fifth indication information, and each of the at least two fifth indication information corresponds to one PT-RS of the at least two PT-RSs and is used to indicate whether the corresponding PT-RS is present.

In some embodiments, the fifth indication information is carried in at least one of following signalings:
downlink control information (DCI), radio resource control (RRC), or a media access control control element (MAC CE).

In some embodiments, the fifth indication information is carried in a first information field of DCI, and the first information field is dedicated to indicating whether a PT-RS is present.

In some embodiments, different state values of the fifth indication information are used to indicate that the PT-RS is present and that the PT-RS is not present.

In some embodiments, the processing unit 510 is further configured to:
determine an absent PT-RS and/or a present PT-RS of the at least two PT-RSs according to the fifth indication information.

In some embodiments, the processing unit 510 is further configured to determine, according to the fifth indication information in combination with a first correspondence, the absent PT-RS and/or the present PT-RS of the at least two PT-RSs, where the first correspondence is used to indicate a correspondence between a state value of the fifth indication information and a situation about whether a PT-RS is present.

In some embodiments, the processing unit 510 is further configured to determine the absent PT-RS and/or the present PT-RS of the at least two PT-RSs according to the fourth indication information in combination with the fifth indication information.

In some embodiments, the processing unit 510 is further configured to:
determine, according to the fourth indication information and the fifth indication information, in combination with a second correspondence, the absent PT-RS and/or the present PT-RS of the at least two PT-RSs, where the second correspondence is used to indicate a correspondence between a state value of the fourth indication information and a DMRS port and a correspondence between a state value of the fifth indication information under the DMRS port and a situation about whether a PT-RS is present.

In some embodiments, the processing unit 510 is further configured to:
determine an absent PT-RS and/or a present PT-RS of the at least two PT-RSs according to a first rule, where the first rule is pre-defined, or the first rule is configured by a network device.

In some embodiments, the processing unit 510 is further configured to:
in a case where fifth indication information is not received, determine the absent PT-RS and/or the present PT-RS of the at least two PT-RSs according to the first rule, where the fifth indication information is used to indicate whether a PT-RS is present.

In some embodiments, the first fule includes:
a PT-RS corresponding to a PUSCH associated with a first spatial parameter being not present.

In some embodiments, the first spatial parameter is a spatial parameter with a smallest index among spatial parameters associated with the at least two PUSCHs.

In some embodiments, the at least two PUSCHs are scheduled via at least two physical downlink control channels (PDCCHs).

In some embodiments, the target indication information includes at least one of:
first indication information, used to indicate a time domain density of a PT-RS;
second indication information, used to indicate a frequency domain density of a PT-RS;
third indication information, used to indicate an RE offset of a PT-RS;
fourth indication information, used to indicate an association between a PT-RS port and a DMRS port; or
sixth indication information, used to determine resource locations of the at least two PT-RSs.

In some embodiments, the sixth indication information is used to indicate an additional RE offset of a PT-RS, and the additional RE offset is an additional offset relative to a reference RE offset; where the reference RE offset is indicated by the third indication information.

In some embodiments, the additional RE offset of the PT-RS indicated by the sixth indication information is w, the reference RE offset of the PT-RS indicated by the third indication information is t, and a target RE offset of the PT-RS is (t+w) mod (12), where mod denotes a modulo operation.

In some embodiments, the sixth indication information is used to indicate an additional RE offset associated with a spatial parameter.

In some embodiments, an additional RE offset associated with a first spatial parameter is a first additional RE offset, and an additional RE offset associated with a second spatial parameter is a second additional RE offset; where the first spatial parameter and the second spatial parameter are different, the first additional RE offset and the second additional RE offset are non-negative integers, and the first additional RE offset and the second additional RE offset are different.

In some embodiments, an index of the first spatial parameter is less than an index of the second spatial parameter.

In some embodiments, the sixth indication information is used to indicate an additional RE offset corresponding to each PT-RS of the at least two PT-RSs; or the sixth indication information is used to indicate additional RE offsets corresponding to a portion of PT-RSs of the at least two PT-RSs.

In some embodiments, different state values of the sixth indication information are used to indicate different additional RE offsets.

In some embodiments, the sixth indication information is carried in at least one of following signalings: DCI, RRC, a MAC CE.

In some embodiments, the processing unit 510 is further configured to:
determine, according to the third indication information and the fourth indication information in combination with at least two correspondences, DMRS ports respectively associated with ports of the at least two PT-RSs and RE offsets of the at least two PT-RSs, where each of the at least two correspondences corresponds to a PT-RS, and the each of the at least two correspondences is used to determine an RE offset mapped by a port of the PT-RS on an associated DMRS port;
where in the at least two correspondences, for third indication information and fourth indication information with a same state value, the at least two PT-RSs are associated with different DMRS ports, and/or RE offsets mapped by the at least two PT-RSs are different.

In some embodiments, the at least two correspondences include a third correspondence and a fourth correspondence, where an RE offset corresponding to a DMRS port j in the third correspondence is same as an RE offset corresponding to a DMRS port i in the fourth correspondence, and i and j are integers and different.

In some embodiments, the at least two correspondences include a fifth correspondence and a sixth correspondence, where in the fifth correspondence and the sixth correspondence, a same DMRS port and a same state value of the third indication information correspond to different RE offsets.

In some embodiments, the processing unit 510 is further configured to:
determine at least portion of the resource locations of the at least two PT-RSs being not overlapped according to a second rule, where the second rule is pre-defined, or the second rule is configured by a network device.

In some embodiments, the processing unit 510 is further configured to:
determine that the at least two PT-RSs correspond to different RE offsets according to the second rule.

In some embodiments, the second rule includes:
an RE offset of a PT-RS corresponding to a PUSCH associated with a third spatial parameter being a third additional RE offset; and/or
an RE offset of a PT-RS corresponding to a PUSCH associated with a fourth spatial parameter being a fourth additional RE offset;
where the third spatial parameter and the fourth spatial parameter are different, the third additional RE offset and the fourth additional RE offset are different, and the third additional RE offset and the fourth additional RE offset are non-negative integers.

In some embodiments, the third additional RE offset is x, and the fourth additional RE offset is y, y=(x+R) mod (12); where R is any positive integer, and mod denotes a modulo operation.

In some embodiments, x is 0.

In some embodiments, an index of the third spatial parameter is less than an index of the fourth spatial parameter.

In some embodiments, the at least two PUSCHs are scheduled via a same PDCCH.

In some embodiments, the first indication information is indicated per PT-RS; and/or the second indication information is indicated per PT-RS; and/or the third indication information is indicated per PT-RS.

In some embodiments, the spatial parameters includes at least one of: transmission configuration indicator (TCI) state information, antenna panel information, transmission reception point (TRP) information, control resource set (CORESET) group information, reference signal set information, reference signal information, beam information, or capability set information.

In some embodiments, the capability set information includes at least one of:
a maximum number of sounding reference signal (SRS) ports, a maximum number of uplink transmission layers, a codebook subset type, an uplink full-power transmission mode, an SRS antenna switching capability, an SRS carrier switching capability, a number of SRS resources transmitted simultaneously, a maximum modulation mode for uplink data transmission, and a maximum modulation mode for downlink data transmission.

Optionally, in some embodiments, the above-mentioned communication unit may be a communication interface or a transceiver, or an input/output interface of a communication chip or a system on chip. The above-mentioned processing unit may be singular or plural.

It should be understood that the network device 500 according to embodiments of the present application may correspond to the network device in the method embodiments of the present application, and the above-mentioned and other operations and/or functions of various units in the network device 500 are for implementing corresponding processes of the network device in the method 300 shown in FIG. 5, and will not be repeated herein for brevity.

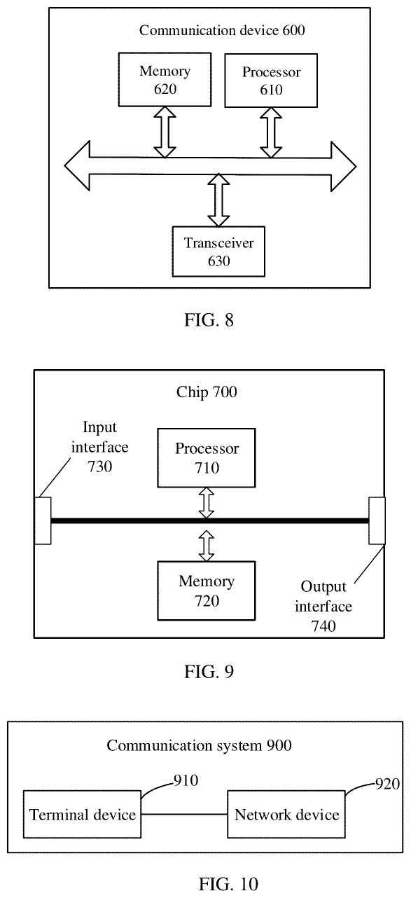

FIG. 8 is a schematic block diagram of a communication device provided by the embodiments of the present application. The communication device 600 shown in FIG. 8 includes a processor 610, which may call and run a computer program from a memory to implement the methods in the embodiments of the present application.

Optionally, as shown in FIG. 8, the communication device 600 further includes a memory 620. The processor 610 may call and run a computer program from the memory 620 to implement the methods in the embodiments of the present application.

The memory 620 may be a separate component independent of the processor 610, or may be integrated in the processor 610.

Optionally, as shown in FIG. 8, the communication device 600 may further include a transceiver 630, and the processor 610 may control the transceiver 630 to communicate with another device. Specifically, the transceiver 630 may transmit information or data to another device or receive information or data transmitted by another device.

The transceiver 630 may include a transmitter and a receiver. The transceiver 830 may also further include antenna(s), and the number of antennas may be one or more.

Optionally, the communication device 600 may specifically be the network device in the embodiments of the present application, and the communication device 600 may implement corresponding processes implemented by the network device in various methods in the embodiments of the present application, which will not be repeated here for brevity.

Optionally, the communication device 600 may specifically be the mobile terminal/terminal device in the embodiments of the present application, and the communication device 600 may implement corresponding processes implemented by the mobile terminal/terminal device in various methods in the embodiments of the present application, which will not be repeated here for brevity.

FIG. 9 is a schematic diagram showing the structure of a chip according to the embodiments of the present application. The chip 700 shown in FIG. 9 includes a processor 710, which may call and run a computer program from a memory to implement the methods in the embodiments of the present application.

Optionally, as shown in FIG. 9, the chip 700 may further include a memory 720. The processor 710 may call and run a computer program from the memory 720 to implement the methods in the embodiments of the present application.

The memory 720 may be a separate component independent of the processor 710, or may be integrated in the processor 710.

Optionally, the chip 700 may further include an output interface 730. The processor 710 may control the input interface 730 to communicate with another device or chip, specifically, to obtain information or data transmitted by another device or chip.

Optionally, the chip 700 may further include an output interface 740. The processor 710 may control the output interface 740 to communicate with other devices or chips, specifically, to output information or data to other devices or chips.

Optionally, the chip may be applied to the network device in the embodiments of the present application, and the chip may implement the corresponding processes implemented by the network device in the various methods of the embodiments of the present application.

Optionally, the chip may be applied to the mobile terminal/terminal device in the embodiments of the present application, and the chip may implement corresponding processes implemented by the mobile terminal/terminal device in various methods in the embodiments of the present application, which will not be repeated here for brevity.

It should be understood that the chips mentioned in the embodiments of the present application can also be called system-level chip, system chip, chip system or system-on-chip chip.

FIG. 10 is a schematic block diagram of a communication system 900 provided by the embodiments of the present application. As shown in FIG. 10, the communication system 900 includes a terminal device 910 and a network device 920.

The terminal device 910 may be configured to implement the corresponding functions implemented by the terminal device in the above-mentioned methods, and the network device 920 may be configured to implement the corresponding functions implemented by the network device in the above-mentioned methods, which will not be repeated herein for brevity.

It should be understood that the processor in the embodiments of the present application may be an integrated circuit chip with a capability for processing signals. In an implementation process, various steps of the method embodiments described above may be completed through an integrated logic circuit of hardware in a processor or instructions in a form of software. The processor described above may be a general purpose processor, a digital signal processor (DSP), an application specific integrated circuit (ASIC), a field programmable gate array (FPGA), or another programmable logic device, a discrete gate or transistor logic device, or a discrete hardware component. The processor may implement various methods, steps, and logic block diagrams disclosed in the embodiments of the present application. The general purpose processor may be a microprocessor or the processor may be any conventional processor. The steps of the methods disclosed in connection with the embodiments of the present application may be directly embodied by execution of a hardware decoding processor, or by execution of a combination of hardware and software modules in a decoding processor. The software modules may be located in a storage medium commonly used in the art, such as a random access memory, a flash memory, a read-only memory, a programmable read-only memory or an electrically erasable programmable memory, or a register. The storage medium is located in a memory, and the processor reads information in the memory and completes the steps of the above methods in combination with hardware of the processor.

It will be appreciated that the memory in the embodiments of the present application may be a transitory memory or a non-transitory memory, or may include both transitory and non-transitory memories. The non-volatile memory may be a read-only memory (ROM), a programmable read-only memory (PROM), an erasable programmable read-only memory (EPROM), or an electrically erasable programmable read-only memory (EEPROM) or a flash memory. The transitory memory may be a random access memory (RAM) which serves as an external cache. As an example, but not as a limitation, many forms of RAMs are available, such as a static RAM (SRAM), a dynamic RAM (DRAM), a synchronous DRAM (SDRAM), a double data rate SDRAM (DDR SDRAM), an enhanced SDRAM (ESDRAM), a synchlink DRAM (SLDRAM), and a direct rambus RAM (DR RAM). It should be noted that the memories of the systems and methods described herein are intended to include, but are not limited to, these and any other suitable types of memories.

It should be understood that the above memories are described as examples rather than limitations. For example, the memory in the embodiments of the present application may be a static RAM (SRAM), a dynamic RAM (DRAM), a synchronous DRAM (SDRAM), a double data rate SDRAM (DDR SDRAM), an enhanced SDRAM (ESDRAM), a synchlink DRAM (SLDRAM), or a direct Rambus RAM (DR RAM). That is to say, the memories in the embodiments of the present application are intended to include, but are not limited to, these and any other suitable types of memories.

The embodiments of the present application further provide a non-transitory computer-readable storage medium configured to store a computer program.

Optionally, the non-transitory computer-readable storage medium may be applied to the network device in the embodiments of the present application, and the computer program causes a computer to perform corresponding processes implemented by the network device in various methods in the embodiments of the present application, which will not be repeated here for brevity.

Optionally, the non-transitory computer-readable storage medium may be applied to the mobile terminal/terminal device of the embodiments of the present application, and the computer program causes a computer to perform corresponding processes implemented by the mobile terminal/terminal device in various methods in the embodiments of the present application, which will not be repeated here for brevity.

The embodiments of the present application further provide a computer program product, including computer program instructions.

Optionally, the computer program product may be applied to the network device in the embodiments of the present application, and the computer program instructions cause a computer to perform corresponding processes implemented by the network device in various methods in the embodiments of the present application, which will not be repeated here for brevity.

Optionally, the computer program product may be applied to the mobile terminal/terminal device in the embodiments of the present application, and the computer program instructions cause a computer to perform corresponding processes implemented by the mobile terminal/terminal device in various methods in the embodiments of the present application, which will not be repeated here for brevity.

The embodiments of the present application further provide a computer program product, including computer program instructions.

Optionally, the computer program may be applied to the network device in the embodiments of the present application. The computer program, when running on a computer, causes the computer to perform corresponding processes implemented by the network device in various methods in the embodiments of the present application, which will not be repeated here for brevity.

Optionally, the computer program may be applied to the mobile terminal/terminal device in the embodiments of the present application. The computer program, when running on a computer, causes the computer to perform corresponding processes implemented by the mobile terminal/terminal device in various methods in the embodiments of the present application, which will not be repeated here for brevity.

Those of ordinary skills in the art will recognize that units and algorithm steps of various examples described in connection with the embodiments disclosed herein may be implemented in electronic hardware, or a combination of computer software and electronic hardware. Whether these functions are implemented in a form of hardware or software depends on a specific application and a design constraint of a technical solution. Those skilled in the art may use different methods to implement the described functions for each specific application, but such implementation should not be considered to be beyond the scope of the present application.

Those skilled in the art may clearly understand that for convenience and conciseness of description, specific working processes of the systems, devices/apparatuses, and units described above may refer to corresponding processes in the aforementioned method embodiments, and details will not be repeated here.

In several embodiments according to the present application, it should be understood that the disclosed systems, devices/apparatuses, and methods may be implemented in other ways. For example, the device/apparatus embodiments described above are only illustrative, for example, the division of the units is only a logical function division, and there may be other division manners in actual implementation. For example, multiple units or components may be combined or integrated into another system, or some features may be ignored or not executed. In addition, coupling or direct coupling or communication connection shown or discussed between each other, which may be indirect coupling or communication connection between the devices or units via some interfaces, may be electrical, mechanical, or in other forms.

The units described as separate components may be or may be not physically separated, and the component shown as a unit may be or may be not a physical unit, i.e., it may be located in one place or may be distributed on multiple network units. Some or all of units may be selected according to actual needs to achieve purposes of technical solutions of the embodiments.

In addition, various functional units in various embodiments of the present application may be integrated in one processing unit, or various units may be physically present separately, or two or more units may be integrated in one unit.

The functions, if implemented in a form of software functional units and sold or used as an independent product, may be stored in a non-transitory computer-readable storage medium. For such understanding, the technical solutions of the present application, in essence, or the part which contributes to the prior art, or part of the technical solutions, may be embodied in the form of a software product, in which the computer software product is stored in one storage medium including a number of instructions for causing one computer device (which may be a personal computer, a server, or a network device) to perform all or some of the steps of the methods according to various embodiments of the present application. The aforementioned storage media includes various media capable of storing program codes, such as a U disk, a mobile hard disk, a read-only memory (ROM), a random access memory (RAM), a magnetic disk, an optical disk, and the like.

The foregoing are merely specific embodiments of the present application, but the protection scope of the present application is not limited thereto. Any person skilled in the art may readily conceive variations or substitutions within the technical scope disclosed by the present application, which should be included within the protection scope of the present application. Therefore, the protection scope of the present application shall be subject to the protection scope of the claims.

What is claimed is:

1. A method for wireless communication, comprising:
determining, by a terminal device, a transmission mode for at least two phase-tracking reference signals (PT-RSs), wherein the at least two PT-RSs correspond to at least two physical uplink shared channels (PUSCHs); and
transmitting the at least two PUSCHs according to the transmission mode for the at least two PT-RSs, wherein the at least two PUSCHs are associated with different spatial parameters;
wherein the transmission mode for the at least two PT-RSs includes at least one of:
a portion of PT-RSs of the at least two PT-RSs being not transmitted; or
at least portion of resource locations of the at least two PT-RSs being not overlapped.

2. The method according to claim 1, wherein the at least portion of the resource locations of the at least two PT-RSs being not overlapped comprises RE offsets of the at least two PT-RSs being different.

3. The method according to claim 1, wherein determining, by the terminal device, the transmission mode for the at least two phase-tracking reference signals (PT-RSs) comprises:
determining the transmission mode for the at least two PT-RSs according to target indication information, wherein the target indication information is used to indicate transmission information of the at least two PT-RSs.

4. The method according to claim 3, wherein the target indication information comprises at least one of:
first indication information, used to indicate a time domain density of a PT-RS;
second indication information, used to indicate a frequency domain density of a PT-RS;
third indication information, used to indicate a resource element (RE) offset of a PT-RS;
fourth indication information, used to indicate an association between a PT-RS port and a demodulation reference signal (DMRS) port; or
fifth indication information, used to indicate whether a PT-RS is present.

5. The method according to claim 4, wherein the target indication information comprises one fifth indication information, and the fifth indication information is used to indicate whether each PT-RS of the at least two PT-RSs is present; or
the target indication information comprises at least two fifth indication information, and each of the at least two fifth indication information corresponds to one PT-RS of the at least two PT-RSs and is used to indicate whether the corresponding PT-RS is present.

6. The method according to claim 5, wherein the fifth indication information is carried in at least one of following signalings:
downlink control information (DCI), radio resource control (RRC), or a media access control control element (MAC CE).

7. The method according to claim 4, wherein determining the transmission mode for the at least two PT-RSs according to the target indication information comprises:
determining an absent PT-RS and/or a present PT-RS of the at least two PT-RSs according to the fifth indication information;
or
determining the transmission mode for the at least two PT-RSs according to the target indication information comprises:
determining the absent PT-RS and/or the present PT-RS of the at least two PT-RSs according to the fourth indication information in combination with the fifth indication information.

8. The method according to claim 1, wherein determining, by the terminal device, the transmission mode for the at least two phase-tracking reference signals (PT-RSs) comprises:
determining an absent PT-RS and/or a present PT-RS of the at least two PT-RSs according to a first rule, wherein the first rule is pre-defined, or the first rule is configured by a network device.

9. The method according to claim 8, wherein determining the absent PT-RS and/or the present PT-RS of the at least two PT-RSs according to the first rule comprises:
in a case where fifth indication information is not received, determining the absent PT-RS and/or the present PT-RS of the at least two PT-RSs according to the first rule, wherein the fifth indication information is used to indicate whether a PT-RS is present.

10. The method according to claim 8, wherein the first fule comprises:
a PT-RS on a PUSCH associated with a first spatial parameter being not present;
the first spatial parameter is a spatial parameter with a smallest index among spatial parameters associated with the at least two PUSCHs.

11. The method according to claim 3, wherein the target indication information comprises at least one of:
first indication information, used to indicate a time domain density of a PT-RS;
second indication information, used to indicate a frequency domain density of a PT-RS;
third indication information, used to indicate an RE offset of a PT-RS;
fourth indication information, used to indicate an association between a PT-RS port and a DMRS port; or
sixth indication information, used to determine resource locations of the at least two PT-RSs.

12. The method according to claim 11, wherein the sixth indication information is used to indicate an additional RE offset of a PT-RS, and the additional RE offset is an additional offset relative to a reference RE offset; wherein the reference RE offset is indicated by the third indication information.

13. The method according to claim 11, wherein determining the transmission mode for the at least two PT-RSs according to the target indication information comprises:
determining, according to the third indication information and the fourth indication information in combination with at least two correspondences, DMRS ports respectively associated with ports of the at least two PT-RSs and RE offsets of the at least two PT-RSs, wherein each of the at least two correspondences corresponds to a PT-RS, and the each of the at least two correspondences is used to determine an RE offset mapped by a port of the PT-RS on an associated DMRS port;
wherein in the at least two correspondences, for third indication information and fourth indication information with a same state value, the at least two PT-RSs are associated with different DMRS ports, and/or RE offsets mapped by the at least two PT-RSs are different.

14. The method according to claim 1, wherein determining, by the terminal device, the transmission mode for the at least two phase-tracking reference signals (PT-RSs) comprises:
determining at least portion of the resource locations of the at least two PT-RSs being not overlapped according to a second rule, wherein the second rule is pre-defined, or the second rule is configured by a network device.

15. The method according to claim 14, wherein determining the at least portion of the resource locations of the at least two PT-RSs being not overlapped according to the second rule comprises:
determining that the at least two PT-RSs correspond to different RE offsets according to the second rule.

16. A network device, comprising a processor and a memory, wherein the memory is configured to store a computer program, and the processor is configured to invoke and execute the computer program stored in the memory to perform:
determining a transmission mode for at least two phase-tracking reference signals (PT-RSs), wherein the at least two PT-RSs correspond to at least two physical uplink shared channels (PUSCHs); and
receiving the at least two PUSCHs according to the transmission mode for the at least two PT-RSs, wherein the at least two PUSCHs are associated with different spatial parameters;
wherein the transmission mode for the at least two PT-RSs includes at least one of:
a portion of PT-RSs of the at least two PT-RSs being not transmitted; or
at least portion of resource locations of the at least two PT-RSs being not overlapped.

17. The network device according to claim 16, wherein the at least portion of the resource locations of the at least two PT-RSs being not overlapped comprises RE offsets of the at least two PT-RSs being different.

18. The network device according to claim 16, wherein determining the transmission mode for the at least two phase-tracking reference signals (PT-RSs) comprises:
determining the transmission mode for the at least two PT-RSs according to target indication information, wherein the target indication information is used to indicate transmission information of the at least two PT-RSs.

19. The network device according to claim 18, wherein the target indication information comprises at least one of:
first indication information, used to indicate a time domain density of a PT-RS;
second indication information, used to indicate a frequency domain density of a PT-RS;
third indication information, used to indicate a resource element (RE) offset of a PT-RS;
fourth indication information, used to indicate an association between a PT-RS port and a demodulation reference signal (DMRS) port; or
fifth indication information, used to indicate whether a PT-RS is present;
or
the target indication information comprises at least one of:
first indication information, used to indicate a time domain density of a PT-RS;
second indication information, used to indicate a frequency domain density of a PT-RS;
third indication information, used to indicate an RE offset of a PT-RS;
fourth indication information, used to indicate an association between a PT-RS port and a DMRS port; or
sixth indication information, used to determine resource locations of the at least two PT-RSs.

20. A terminal device, comprising a processor and a memory, wherein the memory is configured to store a computer program, and the processor is configured to invoke and execute the computer program stored in the memory to perform:
determining a transmission mode for at least two phase-tracking reference signals (PT-RSs), wherein the at least two PT-RSs correspond to at least two physical uplink shared channels (PUSCHs); and
transmitting the at least two PUSCHs according to the transmission mode for the at least two PT-RSs, wherein the at least two PUSCHs are associated with different spatial parameters;
wherein the transmission mode for the at least two PT-RSs includes at least one of:
a portion of PT-RSs of the at least two PT-RSs being not transmitted; or
at least portion of resource locations of the at least two PT-RSs being not overlapped.
